(19) United States
(12) Patent Application Publication
(10) Pub. No.: US 2022/0082741 A1
(43) Pub. Date: Mar. 17, 2022

(54) GLASSES AND POLYMER FILMS WITH EMBEDDED COLLECTIONS OF METAL AND SEMICONDUCTOR NANOCRYSTALS THAT BLOCK THE INFRARED LIGHT

(71) Applicant: Ohio University, Athens, OH (US)

(72) Inventor: Alexander O. Govorov, Athens, OH (US)

(21) Appl. No.: 16/634,277

(22) PCT Filed: Jul. 27, 2018
(86) PCT No.: PCT/US2018/044129

§ 371 Date: Jan. 27, 2020

Related U.S. Application Data
(60) Provisional application No. 62/538,038, filed on Jul. 28, 2017.

(51) Int. Cl. G02B 5/22; G02B 5/20; G02B 5/00

(52) U.S. Cl. CPC G02B 5/226; G02B 5/208; B82Y 30/00; G02B 5/008; G02B 5/207

(57) ABSTRACT

A composition including a first population of one or more plasmonic nanocrystals having a first, narrow extinction range, and one or more additional populations of one or more plasmonic nanocrystals, each of the one or more additional populations having a unique additional, narrow extinction range. An absorbance spectrum of the composition is characterized by the first, narrow extinction range and the one or more additional, narrow extinction ranges that together block infrared light wavelengths.

### CROSS-REFERENCE TO RELATED APPLICATIONS

This application claims priority to, and the benefit of the filing date of, U.S. Patent Application Ser. No. 62/538,038, entitled “Glasses and Polymer Films with Embedded Collections of Metal and Semiconductor Nanocrystals that Block the Infrared Light,” filed Jul. 28, 2017, the disclosure of which is incorporated by reference herein in its entirety.

### FIELD OF THE INVENTION

The present invention relates generally to the field of nanotechnology, and more particularly, to compositions that contain nanostructures and that tend to selectively filter light.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Owing to the tremendous advancement in both theoretical understanding of nanophotonics and fabrication techniques for nanostructures, plasmonic nanomaterials have received great attention in the past decades. When light interacts with a plasmonic nanomaterial, free electrons in the nanomaterial oscillate resonantly in response to the incident light, a phenomenon known as localized surface plasmon resonance (LSPR) in the case of nanoparticles and surface plasmon polariton in the case of metal-dielectric interfaces. Surface plasmons can enhance electromagnetic field intensity by several orders of magnitude, usually near sharp points or edges of the nanostructures or in the narrow space between neighboring nanostructures, and have been utilized in various applications such as surface enhanced raman spectroscopy, first documented in 1973 [Fleischmann, M.; Hendra, P. J.; McQuillan, A. J., Chem. Phys. Lett. 1974, 26, 163-166]. In addition, surface plasmons can also result in far-field extinction (sum of absorption and scattering) near resonant wavelengths, opening opportunities for exciting applications such as photothermal treatment [Huang, X.; Jain, P. K.; EI-Sayed, I. H.; EI-Sayed, M. A. Laser. Med. Sci. 2008, 23, 217], plasmonic photocatalysis [Awazu, K.; Fujimaki, M.; Rockstuhl, C.; Tominaga, J.; Murakami , H.; Ohki, Y.; Yoshida, N.; Watanabe, T. J. Am. Chem. Soc. 2008, 130, 1676-1680; and Zhang, X.; Chen, Y. L.; Liu, R.-S.; Tsai, D. P. Rep. Prog. Phys. 2013, 76, 046401], and new isotropic optical materials with specially tailored spectra across the whole electromagnetic spectrum from the UV to the visible [Zhang, H.; Demir, H. V.; Govorov, A. O., ACS Photonics 2014, 1, 822-832; and Besteiro, L. V.; Gungor, K.; Demir, H. V.; Govorov, A. O. J. Phys. Chem. C, 2017, 121, 2987-2997].

The vast majority of research in plasmonic nanomaterials has been focused on nanostructures made of gold and silver. In addition to its nontoxicity and resistance to oxidation, gold has a strong plasmon resonance in the visible spectrum and can be readily fabricated into different nanostructures via solution phase synthesis [Hu, M.; Chen, J.; Li, Z. Y.; Au, L.; Hartland, G. V.; Li, X.; Marquez, M.; Xia, Y. Chem Soc. Rev., 2006, 35, 1084-1094; Liu, A.; Xu, T.; Ren, Q.; Yuan, M.; Dong, W.; Tang, W. Electrochem. Comm. 25, 74-78; Dickerson, E. B.; Dreaden, E. C.; Huang, X.; EI-Sayed, I. H.; Chu, H.; Pushpanketh McDonald, J. F.; EI-Sayed, M. A. Cancer Lett. 2008, 269, 57-66; Zhang, H.; Li, Y.; Ivanov, I. A.; Qu, Y.; Huang, Y.; Duan, X. Angew. Chem. 2010, 122, 2927-2930; Chen, H.; Shao, L.; Li, Q.; Wang, J. Chem. Soc. Rev. 2013, 42,2679-2724; Becker, J.; Trügler, A.; Jakab, A.; Hohenester, U.; Sonnichsen, C. Plasmonics 2010, 161-167; McMahon, J. M.; Henry, A. I.; Wustholz, K. L.; Natan, M. J.; Freeman, R. G.; Van Duyne, R. P.; Schatz, G. C. Anal. Bioanal. Chem. 2009, 394, 1819-1825; Busbee, B. D.; Obare, S. 0.; Murphy, C. J. Adv. Mater. 2003, 15, 414-416; Jana, N. R.; Gearhart, L.; Murphy, C. J., J. Phys Chem B, 2001, 105, 4065-4067; Perrault, S. D.; Chan W. C., J. Am. Chem. Soc., 2009, 131, 17042-17043]. Similarly, silver nanostructures [Awazu, K.; Fujimaki, M.; Rockstuhl, C.; Tominaga, J.; Murakami , H.; Ohki, Y.; Yoshida, N.; Watanabe, T. J. Am. Chem. Soc. 2008, 130, 1676-1680; Rycenga, M. et al, Chem. Rev. 2011, 111, 3669-3712; Pyayt, A. L. et al., Nat. Nanotech, 2008, 3, 660-665; Science, 2012, 337, 450-453; Tao, A. et al., Nat. Nanotech, 2007, 2, 435-440; Pietrobon, B. et al, ACS Nano, 2008, 3, 21-26] have strong plasmon resonances near the blue end of the visible spectrum, although they are less resistant to oxidation.

More recently, alternative plasmonic materials have seen a strong increase in attention, both to gain access to inexpensive and more abundant materials, and also to broaden the spectral range of nanomaterial plasmonics. For example, aluminum offers a higher free carrier density than silver and gold, and thus enables plasmonic nanostructures with resonances in the UV range of the spectrum [Ekinici, Y., et al, J. Appl. Phys., 2008, 104, 083107; and Knight, M. W., et al, ACS Nano, 2014, 8, 834-840]. When in contact with air, however, a self-limiting oxide layer forms on the aluminum surface and results in an attenuation and red-shift of the LSPR. Copper is another potentially interesting plasmonic material though only a few works have been reported to date. Chan et al. fabricated copper nanoparticles on glass and silicon substrates via nanoparticle lithography [Chan, G. H.; Zhao, J.; Hicks, E. M.; Schatz, G. C.; Van Duyne, R. P., Nano Lett., 2007, 7, 1947-1952]. The authors showed size tunable LSPRs between ˜600 nm-900 nm. Zong et al. studied the optical response of copper nanorods and nanowires embedded in aluminum oxide, prepared by alternating current electrodeposition [Zong, R. L.; Zhou, J.; Li, B.; Fu, M.; Shi, S. K.; Li, L. T. J. Chem. Phys., 2005, 123, 094710-6]. This work showed some slightly tunable LSPRs around 550 nm. Chen et al. developed a hydrothermal route for nearly spherical and cubic copper nanoparticles and reported plasmon resonance between 600 nm and 800 nm [Chen, H.; Lee, J. H.; Kim, Y. H.; Shin, D. W.; Park, S. C.; Meng, X.; Yoo, J. B., Journal of nanoscience and nanotechnology 2010, 10, 629-636]. Wang et al. fabricated copper nanoshells via seeded electrodeless plating and observed slightly tunable LSPRs between 600 nm and 850 nm [Wang, H.; Tam, F.; Grady, N. K.; Halas, N. J. The Journal of Physical Chemistry B, 2005, 109, 18218-18222].

In addition to the material's carrier density, the LSPR behavior can also be controlled by the shape of the nanomaterial. While spherical nanoparticles exhibit a single dipolar LSPR peak tunable via diameter, anisotropic nanostructures such as nanocaps, nanocups, and nanorods offer greater control over LSPR wavelengths as they have more geometry parameters to manipulate. As a result of anisotropy, electron oscillations in different directions give rise to plasmon resonance peaks at different wavelengths. Specifically, in the case of nanocups, the main plasmon resonance peaks are significantly red-shifted compared to those of spherical particles and nanoshells [Knight, M. W.; Halas, N. J. New J. Phys. 2008, 10, 105006; King, N. S., et al, ACS Nano, 2011, 5, 7254-7262; Mirin, N. A., et al, Nano Lett., 2009, 9, 1255-1259], usually right into the important near-infrared biological transparency window. Moreover, the transverse plasmon mode of nanocups scatters incoming light into the direction normal to the nanocup rim, irrespective of the incident direction over a large solid angle, making them ideal for directional light coupling [King, N. S., et al, ACS Nano, 2011, 5, 7254-7262; and Mirin, N. A., et al, Nano Lett., 2009, 9, 1255-1259]. Very large near-field enhancements have also been observed near the sharp cup rims [Lu, Y., et al, Nano Lett., 2005, 5, 119-124].

While there are some wet chemistry synthesis methods for gold nanocups or half-shells [He, J.; Zhang, P.; Gong, J.; Nie, Z. Chem. Commun. 2012, 48,7344-7346; Jiang, R.; Qin, F.; Liu, Y.; Ling, X. Y.; Guo, J.; Tang, M.; Cheng, S.; Wang, J. Adv. Mater. 2016, 28, 6322-6331; Rodriguez-Fernandez, D.; Perez-Juste, J.; Pastoriza-Santos, I.; Liz-Marzan, L. M., ChemistryOpen 2012, 1, 90-95; and Charnay, C.; Lee, A.; Man, S.-Q.; Moran, C. E.; Radloff, C.; Bradley, R. K.; Halas, N. J., J. Phys. Chem. B 2003, 107, 7327-7333], there is very limited, if not nonexistent, literature regarding wet chemistry synthesis of nanocups from alternative materials such as copper and aluminum. For these alternative materials, Dorpe et al [ACS Nano, 2011, 5, 6774-6778] provided a comprehensive summary of the different fabrication methods for nanocups involving the use of dielectric cores. In their paper, all the methods were classified into two categories. The first category utilizes chemical plating of dielectric cores to make complete nanoshells, part of which are then removed by anisotropic etching to yield nanocups. The other category starts with immobilization of dielectric cores on substrates, in either a close-packed or an irregular, sparse manner. Then, gas phase deposition such as electron beam evaporation and magnetron sputtering are employed to deposit materials on the dielectric particles. Due to the shadowing effects, the dielectric particles are partially rather than completely covered by the metal, yielding the shapes of nanocaps, half-shells, or nanocups, depending on the coverage percentage.

Further, in the case of close-packed dielectric particles, the nanostructures subsequently deposited would link their neighboring nanostructures at equators or above, making them essentially interconnected half-shells or nanocaps, rather than discrete nanocups. The transport of electrons and plasmon coupling among adjacent nanostructures can result in unwanted broadening and shifting of plasmon resonances [Pramod, P.; Thomas, K. G., Adv. Mater., 2008, 20, 4300-4305; and Romero, I.; Aizpurua, J.; Bryant, G. W.; De Abajo, F. J. G., Opt. Express, 2006, 14, 9988-9999]. Interconnected nanostructures are also difficult to disperse in solvents due to their large sizes and masses, rendering them much less useful in solution phase applications or processings [Yang, J.; Kramer, N. J.; Schramke, K. S.; Wheeler, L. M.; Besteiro, L. V.; Hogan Jr, C. J.; Govorov, A. O.; Kortshagen, U. R., Nano Lett., 2016, 16, 1472-1477; and Wu, H.-J.; Henzie, J.; Lin, W.-C.; Rhodes, C.; Li, Z.; Sartorel, E.; Thorner, J.; Yang, P.; Groves, J. T., Nat Methods, 2012, 9, 1189-1191]. The sparse template approach circumvents the interconnection issue but inevitably reduces the fabrication throughput as a large portion of the substrate is empty and wasted. Moreover, when the nanocups are to be used directly on the substrates, the sparse manner in which the nanocups are arranged results in lower magnitudes for the plasmon resonance peaks.

Designing a material capable of attenuating light in a broad spectral interval while simultaneously exhibiting a narrow transparency window at a given wavelength has proven challenging. Many of the current drawbacks (e.g., expensive materials such as gold and silver, lack of known methods for synthesis for alternative materials such as copper and aluminum, formation of interconnected nanostructures with a corresponding unwanted broadening and shifting of plasmon resonances, etc.), have resulted in such a material remaining elusive. Further, there is a need for inexpensive materials that are capable of being scaled to mass production—which does not currently exist in this field.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

Various aspects may address the drawbacks described above. For example, as mentioned above, currently known methods and uses of plasmonic nanomaterials employ expensive materials such as gold and silver. Additionally, there is a lack of known methods for synthesis when using alternative materials such as copper and aluminum. Further, certain methods that have been employed result in the formation of interconnected nanostructures with a corresponding unwanted broadening and shifting of plasmon resonances. And, there are no current methods for use of inexpensive materials that are capable of being scaled to mass production.

Various aspects described herein overcome these drawbacks (among others described above) based on certain studies—including, but not limited to studies of close-packed yet discrete nanocups made from alternative materials on a colloidal template. One such aspect provides a composition including a first population of one or more plasmonic nanocrystals (NCs) having a first, narrow extinction range, and one or more additional populations of one or more plasmonic nanocrystals, each of the one or more additional populations having a unique additional, narrow extinction range. An absorbance spectrum of the composition is characterized by the first, narrow extinction range and the one or more additional, narrow extinction ranges that together block infrared light wavelengths. The nanocrystals of the first population and of the one or more additional populations may include a nanoshell, a nanostar, a nanocup, a nanoprism, and/or combinations thereof.

Another aspect provides a composition including a first population of one or more semiconductor nanocrystals having a first, broad extinction range, and one or more additional populations of one or more plasmonic nanocrystals, each of the one or more additional populations having a unique additional, narrow extinction range. The first extinction range may be in the UV range, and the second extinction range may be in the infrared range. An absorbance spectrum of the composition is characterized by the first, broad extinction range and the one or more additional, narrow extinction ranges that together block infrared light wavelengths. The nanocrystals of the first population may include a nanosphere. And the nanocrystals of the one or more additional populations may include a nanoshell, a nanostar, a nanocup, a nanoprism, and/or combinations thereof.

Another aspect provides a filter comprising a composition (such as those described above) embedded in a material, wherein the filter provides a transparency to a defined wavelength range.

Yet another aspect provides a method of making a selective light wavelength filter. Such a method may include embedding a composition (such as those described above) an optically-transparent composite material.

### BRIEF DESCRIPTION OF THE DRAWINGS

The accompanying drawings, which are incorporated in and constitute a part of this specification, illustrate embodiments of the invention or other research or information related to the sphere of the invention and, together with the general description of the invention given above and the detailed description of the embodiments given below, serve to explain the principles related to the present invention.

FIGS. 1A and 1B are a pair of graphs showing a desired transmission spectrum of an optically-transparent material, wherein light wavelengths generally greater than 700 nm are blocked.

FIG. 2 is a graph showing that one nanocrystal has a narrow absorption line, thereby indicating a very strong, concentrated absorption.

FIG. 3 is a graph showing the absorbance spectra of a collection of plasmonic/metal nanorods with different plasmonic resonances, wherein the collection of nanocrystals includes several nanocrystals with such sharp absorption lines to obtain an IR-blocking band for wavelengths greater than 700 nm.

FIG. 4A is a geometry model of the copper nanocups.

FIG. 4B is a graph showing a measured extinction spectrum and calculated scattering, absorption, and extinction cross-sections of copper nanocups dispersed in a 1:1 mixture of toluene and acetic acid.

FIG. 5A is a geometry model of the aluminum nanocups.

FIG. 5B is a graph showing a measured extinction spectrum and calculated scattering, absorption, and extinction cross-sections of aluminum nanocups dispersed in toluene.

FIGS. 6A and 6B includes a graph (FIG. 6A) and geometry models (FIG. 6B), wherein the graph shows measured extinction spectra (solid) and calculated extinction cross-sections (dashed) for copper nanocups with different deposition times between 40 seconds and 132 seconds. The measured curves (i.e., those curves shown in the insert to the graph) are scaled to the maximum of the dotted and dashed 90 sec curve for easy comparison. The geometry models of the nanocups used in the simulation are shown at the bottom.

FIG. 7 is a graph showing extinction spectra (not scaled) measured in a 1:1 mixture of toluene and acetic acid for copper nanocups with different deposition times between 40 seconds and 132 seconds.

FIG. 8 is a graph showing measured extinction spectra for copper nanocups deposited on PSL templates of 3 different sizes (127 nm, 214 nm, and 237 nm). The copper deposition time is 132 seconds in all three cases. The dotted and dashed curve (214 nm) and the dashed curve (237 nm) are scaled down to the solid line curve (127 nm) for easy comparison.

FIG. 9 is a graph showing extinction spectra (not scaled) measured in a 1:1 mixture of toluene and acetic acid for copper nanocups on PSL templates of 3 different sizes (127 nm, 214 nm, and 237 nm). The copper deposition time is 132 seconds in all three cases.

FIG. 10 is a graph showing extinction spectra of copper nanocups measured in toluene immediately, 3 days, 7 days, and 13 days after fabrication.

FIG. 11A is a graph showing transmission spectra of commercial low emission coatings with low, moderate, and high solar gain, (adapted from Carmody, J., Residential windows: a guide to new technologies and energy performance; W W Norton & Company, 2007).

FIG. 11B is a graph showing theoretical transmission spectra from a mixture of 90 seconds, 60 seconds, and 40 seconds copper nanocups with a low overall concentration, calculated based on measured extinction spectra (solid curve) and theoretical extinction cross-sections (dashed curve) for each copper nanocup component.

FIG. 12 includes schematics and graphs showing elements of energy-saving windows and related optical properties and characteristics where Panel a) shows the structure of a commercial double-pane argon window. The front pane absorbs the solar IR and, in addition, has a low-E coating on the internal surface for reflection of non-solar thermal radiation (mid- and short-wavelength IR, MW-IR and SW-IR radiation) coming from hot objects in the street and from the hot external window pane itself. Panel b) is an Illustration of a metafilm incorporating a transparent matrix (glass) and a collection of plasmonic nanocrystals of different sizes. Panel c) shows black-body spectrum of the Sun and a hot outside temperature (40° C.). Panel d) shows spectral characteristics of an ideal IR-blocking and low-E window. The outside hot pane has embedded semiconductor and plasmonic nanocrystals that block the solar ultraviolet (UV) and IR radiation. Panel e) shows reflection spectrum of an ideal low-E coating on the internal surface of the hot pane. And Panel f) shows schematics of the absorption spectra of plasmonic nanocrystals to cover the NIR and SW-IR intervals and the semiconductor NCs to block the UV interval.

FIG. 13 includes graphs and a table showing selection of plasmonic glasses (Ag and Cu shells and TiN cups) designed so that the total transmission (Tₜₒₜₐₗ=T_{direct}+T_{diffuse}) is close to the ideal step-wise profile T_{ideal}. The panels show the total transmission profile (solid curve) and the diffuse transmission T_{diffuse} (dashed curve). The table compares the figures of merit of these glasses with the ones obtained by minimizing the distance between direct transmission, T_{direct}, and T_{ideal}. Note that the values in the different columns of the table are not just the result of changing the variables (T_{direct} vs Tₜₒₜₐₗ) used in calculating the figures of merit for the same glasses, but they show values for different glasses, with NC densities obtained by minimizing the distance of either T_{direct} or Tₜₒₜₐₗ with respect to T_{ideal}, respectively.

FIG. 14 includes panels a) and b). Panel a) shows an Ag shell (80 nm, 5 nm) and its external surface charges, accompanied by a diagram of the central slice of a metallic nanoshell with its geometrical parameters. Panel b) shows calculated extinctions of the set of Ag and Cu nanoshells.

FIG. 15 includes graphs and a schematic showing extinction cross sections of the ensemble of nanoshell sizes considered in calculations herein, grouped by material. Note that the proposed glasses (of FIG. 18, described below) use different concentrations of each NC size, as described in Table 1 herein.

FIG. 16 includes graphs and a schematic showing extinction cross sections of the ensemble of nanorod sizes considered in our calculations, grouped by material. Note that the proposed glasses (of FIG. 12, described below) use different concentrations of each NC size, as described in Table 1 herein.

FIG. 17 includes graphs and a schematic showing extinction cross sections of the ensemble of nanocup sizes considered in our calculations, grouped by material. Note that the proposed glasses (of FIG. 12, described below) use different concentrations of each NC size, as described in Table 1 herein.

FIG. 18 shows transmission profiles for glasses embedded with different ensembles of nanoshells. Each different profile has been obtained with nanoshells of only one material, and each panel contains data for ensembles obtained manually and computationally. The specific concentrations of different nanoshell sizes in each ensemble can be found in Tables 1 and 2. The diagram shows a schematic slice of a nanoshell.

FIG. 19 shows transmission profiles for glasses embedded with different ensembles of nanorods (left) and nanocups (right). Each different profile has been obtained with NCs of only one material, and each panel contains data for ensembles obtained manually and computationally. The specific concentrations of different NC sizes in each ensemble can be found in Tables 1 and 2. The diagrams show a schematic slice of a nanorod and a nanocup, respectively.

FIG. 20 include figures of merit for various plasmonic IR-blocking glasses and also for commercial windows, for (a) manual and (b) computational optimization procedures. Some of the proposed plasmonic systems achieve a close-to-ideal SHGC parameter, although the parameters VT and IRT are not ideal (VT<1 and IRT>0), as it is also the case with commercial windows. In this graph, the parameters for commercial windows were taken from the literature. Three cases were observed: window 1 (hollow square)—single-pane clear glass; window 2 (hollow circle)—double pane argon Low-E coating; and window 3 (hollow triangle)—double pane argon Low-E coating. Metaglass data is obtained for the concentrations given in Tables 1 and 2 herein.

FIG. 21 shows values of the spectral ideality parameter, IP, given as Equation 8 herein. This plot is made for the manually designed plasmonic glasses, with transmission profiles shown as black curves in FIGS. 18 and 19. Lower values are better, with an ideal profile having IP=0.

FIG. 22 includes panels a)-c). Panel a) is a schematic of the model of light scattering in the plasmonic glass. Panel b) shows values for the glass of Ag nanoshells. Its transmission profile (top) highlights the wavelengths for which data is shown in panel c) of this figure. The photon mean free path in this glass is compared with its thickness in the panel below. Panel c) shows local density of radiative energy, q(z), as obtained with Equation S1 (shown later herein), for three different wavelengths.

FIG. 23 presents five pairs of panels, each pair corresponding to a different plasmonic glass: Au, Ag, Cu and TiN shells, as well as Al rods. Two insets with the sketch of the geometries are provided with the relevant group of panels. The results shown in this figure account for direct transmission only, i.e. light diffusion is not included. Each pair is composed by (1) a panel with the total direct transmission profile, accompanied by the separate contributions of absorption and scattering and (2) the mean free path at different wavelengths, referenced against the total width of the glass.

FIG. 24 shows transmission profiles of plasmonic glasses composed of ensembles of Ag (left panel) and Cu (right panel) ensembles. Each panel compares data for a glass with the nominal set of NC densities, as described in the main text, with two alternative versions of the ensemble that broaden the NP size distribution, as shown in Table 3 herein. The transmission profiles are robust to this broadening, and the figures of merit show a small absolute and relative change for the central glass parameters VT and SHGC.

FIG. 25 includes a schematic showing the structure of a commercial double-pane argon window. The front pane absorbs the solar IR and, in addition, has a low-E coating on the internal surface for reflection of non-solar thermal radiation (mid- and short-wavelength IR, MW-IR and SW-IR radiation) coming from hot objects in the street and from the hot external window pane itself. The inset of that schematic is an Illustration of a metafilm incorporating a transparent matrix (glass) and a collection of plasmonic nanocrystals of different sizes. FIG. 25 also includes a graph showing a manually optimized transmission profile of a glass embedded with Ag nanoshells.

### DETAILED DESCRIPTION

One or more specific embodiments of the present invention will be described below along with other research or information related to the sphere of the invention. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described above, various aspects of the present invention, or other research or information related to the sphere of the invention, address the drawbacks described above. For example, as mentioned above, currently know methods and uses of plasmonic nanomaterials employ expensive materials such as gold and silver. Additionally, there are a lack of known methods for synthesis when using alternative materials such as copper and aluminum. Further, certain methods that have been employed result in the formation of interconnected nanostructures with a corresponding unwanted broadening and shifting of plasmon resonances. And, there are no current methods for use of inexpensive materials that are capable of being scaled to mass production.

Various aspects of the present invention can address or inform the drawbacks described above. Certain aspects, or other research or information related to the sphere of the invention, may be based on studies of the plasmonic properties of close-packed yet discrete nanocups made from alternative materials (e.g., copper, aluminum, etc.). Specifically, both aluminum and copper nanocups were studied. The disclosure herein focuses primarily on the copper nanocups as they demonstrated sharper and stronger plasmon resonances (although this does not dismiss the utility of aluminum). While nanocups were sometimes used interchangeably with half-shells or nanocaps, herein the more rigorous nomenclature [Liu, J.; Cankurtaran, B.; McCredie, G.; Ford, M.; Wieczorek, L.; Cortie, M., Nanotechnology, 2005, 16, 3023] is adopted, where nanocups strictly refer to dielectric cores with a shell coverage of more than 50 percent.

While plasmonic nanostructures have been explored by other researchers before [Frederiksen, M.; Bochenkov, V. E.; Cortie, M. B.; Sutherland, D. S. J. Phys. Chem. C 2013, 117, 15782-15789; Xiao, G.N.; Man, S. Q. J. Phys. Chem. Solids 2012, 73, 604-607; Zhan, P.; Wang, Z.; Dong, H.; Sun, J.; Wu, J.; Wang, H. T.; Zhu, S.; Ming, N.; Zi, J. Adv. Mater. 2006, 18, 1612-1616; Liu, J.; Maaroof, A. I.; Wieczorek, L.; Cortie, M. B. Adv. Mater. 2005, 17, 1276-1281; Sugawa, K.; Tamura, T.; Tahara, H.; Yamaguchi, D.; Akiyama, T.; Otsuki J.; Kusaka, Y.; Fukuda, N.; Ushijima, H. ACS Nano 2013, 7,9997-10010; Wollet, L.; Frank, B.; Schäferling, M.; Mesch, M.; Hein, S.; Giessen, H. Opt. Mater. Express, 2012, 2, 1384-1390; Adv. Funct. Mater., 2013, 23, 720-730; Zhu, X.; Xiao, S.; Shi, L.; Liu, X.; Zi, J.; Hansen, O.; Mortensen, N. A. Opt. Express 2012, 20, 5237-5242; and Chen, Z.; Zhan, P.; Dong, W.; Li, Y.; Tang, C.; Min, N.; Wang, Z. Chinese Sci. Bull. 2010, 55, 2600-2607] and summarized by Dorpe et al. [ACS Nano., 2011, 5, 6774-6778], the vast majority of that research focused on noble metals such as gold and silver (expensive materials), and the nanostructures, whether nanocups, nanocaps, or half-shells, were often interconnected with neighboring nanostructures (i.e., one of the drawbacks with the current state of the art noted above in the Background). The present disclosure however, includes descriptions of research or information related to the sphere of the invention, including discrete and well-defined copper and aluminum nanocups having the properties described herein. While Jian et al. experimentally and theoretically studied copper and aluminum nanocups fabricated on sparse colloidal templates, aspects of the present invention, or other research or information related to the sphere of the invention described herein, provide nanostructures having sharper and more resolved plasmon resonance peaks and better agreements between experimental and calculated extinction spectra (than that of Jian et al). Herein is also reported the absolute intensities of the plasmon resonance peaks to give a better idea of plasmonic performance, (which were not reported by Jian et al).

Nanocrystals made of inexpensve plasmonic metals, like those described herein, look very interesting for optical applications such as meta-solutions and meta-films [Zhang, H.; Demir, H. V.; Govorov, A. O., ACS Photonics, 2014, 1, 822; and Besteiro, L. V.; Gungor, K.; Demir, H. V.; Govorov, A. O., J. Phys. Chem. C, 2017, 121, 2987-2997]. A mixture of plasmonic nanocrystals of different sizes and shapes can be used to design interesting and potentially useful materials with tailored transmission spectra in the visible and IR spectral intervals. For example, meta-solutions and meta-films with a narrow transmission window placed in the IR spectral interval were designed using collections of plasmonic nanorods, nanocrosses, and semiconductor quantum dots [Zhang, H.; Demir, H. V.; Govorov, A. O., ACS Photonics, 2014, 1, 822; and Besteiro, L. V.; Gungor, K.; Demir, H. V.; Govorov, A. O., J. Phys. Chem. C, 2017, 121, 2987-2997]. It is noted that, so far, mostly noble nanocrystals were considered for applications of this kind since mostly gold and silver nanocrystals exhibit narrow plasmon peaks. However, the disclosure herein demonstrates that copper and aluminum nanocrystals also show potential for applications of this kind. These nanocrystals show narrow and tunable plasmon resonances in wide spectral intervals and are made of inexpensive metals (e.g., metals that are less expensive than gold or silver).

Further, as will be described in the Example 1, below, tunability of the main plasmon resonance peak between 900 nm and 1500 nm, which is significantly larger than that reported for other copper nanostructures, may be achieved by varying shell thickness and particle size. Further, excellent agreements are found between experimental and calculated extinction spectra, which validates the geometry model and suggests that the nanocups have a well-defined shape. The main plasmon resonance peak sees a minor red-shift and attenuation after 3 days of oxidation, allowing plenty of time for further processing in air, and eventually approaches stabilization after 13 days. Another aspect of the present invention, or other research or information related to the sphere of the invention, may be or relate to an optical material that blocks near-infrared but transmits visible light, the material being constructed by mixing nanocups, such as copper nanocups, of different sizes at appropriate ratios. One embodiment of this involves mixing copper nanocups of three different sizes at appropriate ratios.

And so, one aspect of the present invention, or other research or information related to the sphere of the invention, provides a composition including a first population of one or more plasmonic nanocrystals (NCs) having a first, narrow extinction range, and one or more additional populations of one or more plasmonic nanocrystals, each of the one or more additional populations having a unique additional, narrow extinction range. An absorbance spectrum of the composition is characterized by the first, narrow extinction range and the one or more additional, narrow extinction ranges that together block infrared light wavelengths. Further, in certain embodiments of the composition, a shape of the plasmonic nanocrystals of the first and one or more additional populations may be selected from the following group: a nanorod, a nanostar, a nanoshell, a nanocup, a nanoprism, and a combination thereof.

In certain embodiments of the composition, the plasmonic nanocrystals of the first and one or more additional populations may include a material selected from the following group: gold, silver, copper, aluminum, titanium nitride (TiN), indium tin oxide (ITO), and a combination thereof.

In further embodiments, the absorbance spectrum may be tunable by varying a shell thickness of the first population of nanocrystals.

In still further embodiments, the composition may include a third population of at least one of a semiconductor nanocrystal or a dielectric nanocrystal, the third population having a third extinction range. In such embodiments, the absorbance spectrum of the composition may be further characterized by the third extinction range and include a transparency window characterized by a gap between the third extinction range and the first, narrow extinction range and the one or more additional narrow extinction ranges. In one exemplary embodiment, the third extinction range may block ultraviolet light wavelengths.

In still further embodiments of the composition, the one or more plasmonic nanocrystals of the first population may have a first size, and the one or more additional populations include a second population of one or more plasmonic nanocrystals having a second size and a third population of one or more plasmonic nanocrystals having a third size, wherein the first size is larger than the second size, and the second size is larger than the third size. In a particular embodiment, a ratio of the first population to the second population to the third population is 0.1:0.1:1.3.

Another aspect provides a composition including a first population of one or more semiconductor nanocrystals having a first, broad extinction range, and one or more additional populations of one or more plasmonic nanocrystals, each of the one or more additional populations having a unique additional, narrow extinction range. The first extinction range may be in the UV range, and the second extinction range may be in the infrared range. An absorbance spectrum of the composition is characterized by the first, broad extinction range and the one or more additional, narrow extinction ranges that together block infrared light wavelengths. The nanocrystals of the first population may include a nanosphere. And the nanocrystals of the one or more additional populations may include a nanoshell, a nanostar, a nanocup, a nanoprism, and/or combinations thereof.

In certain embodiments, the first population of nanocrystals may include a nanosphere.

In further embodiments the semiconductor nanocrystals of the first population may include a material selected from titanium dioxide (TiO₂), zinc oxide (ZnO), and a combination thereof.

In still further embodiments, the plasmonic nanocrystals of the one or more additional populations comprise a material selected from the following group: gold, silver, copper, aluminum, titanium nitride (TiN), indium tin oxide (ITO), and a combination thereof.

In further embodiments, the the plasmonic nanocrystals may be nanoshells or nanocups, and the absorbance spectrum may be tunable by varying a shell thickness and a shell size of the plasmonic nanocrystals.

In still further embodiments, the plasmonic nanocrystals may be nanoprisms or nanorods, and the absorbance spectrum may be tunable by varying a shell size of the plasmonic nanocrystals.

Embodiments of the present invention, or other research or information related to the sphere of the invention, are directed to inexpensive, optically-transparent composite materials that act as a smart window to allow passage of visible light while simultaneously blocking other light, such as infrared light (IR) (e.g., wavelength greater than 700 nm) and/or ultraviolet (UV) light. And, further embodiments of the present invention, or other research or information related to the sphere of the invention, may incorporate a precisely-designed collection of plasmonic, semiconductor, and dielectric nanocrystals for transparent films to create the IR-light blocking effect.

To that end, another aspect of the present invention, or other research or information related to the sphere of the invention, may provide a filter comprising a composition (e.g., the various embodiments of any of the compositions described above and elsewhere herein) embedded in a material, wherein the filter provides a transparency to a defined wavelength range.

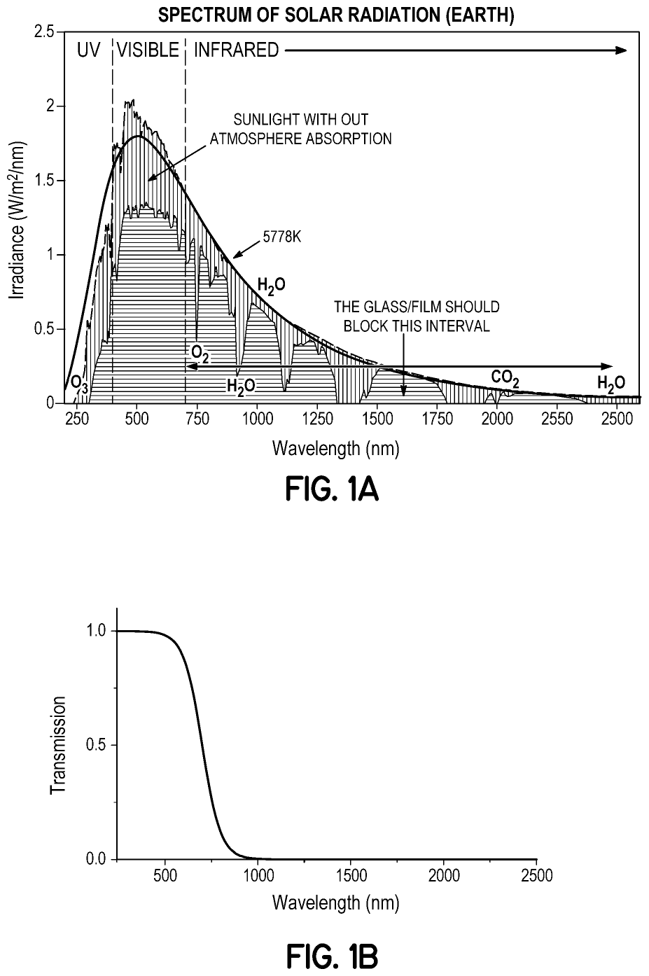

In an embodiment, a collection of nanocrystals of different sizes, shapes, and/or materials are embedded into an optically-transparent material. The nanocrystals are dispersed randomly inside the optically-transparent medium, but the composition of nanocrystals may be precisely designed. With reference to FIGS. 1A and 1B, a desired transmission spectrum of the optically-transparent material is shown in which light wavelengths generally greater than 700 nm are blocked.

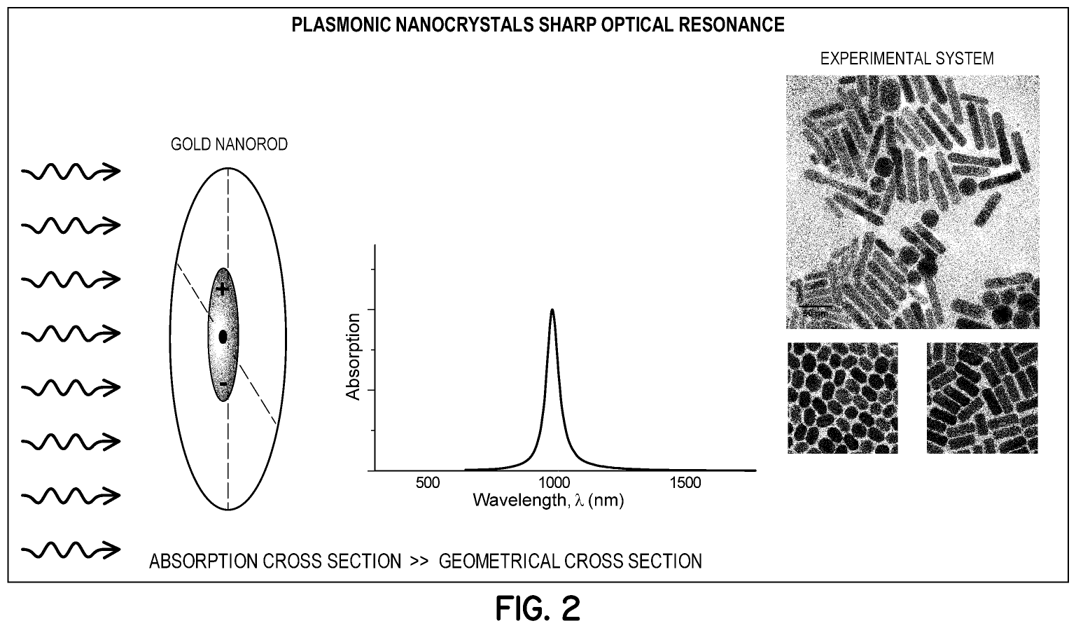

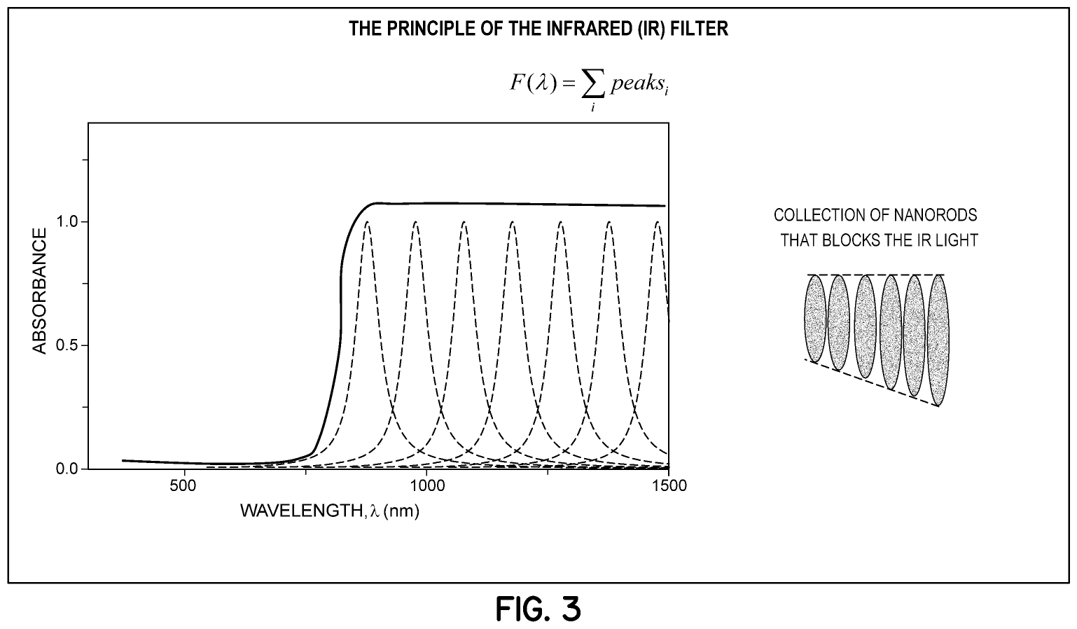

Plasmonic nanocrystals create a sharp/abrupt edge of the transmission. As shown in FIG. 2, one nanocrystal has a narrow absorption line (FIG. 2) indicating a very strong, concentrated absorption. FIG. 3 shows the absorbance spectra of a collection of plasmonic/metal nanorods with different plasmonic resonances. The collection of nanocrystals includes several nanocrystals with such sharp absorption lines to obtain the IR-blocking band for wavelengths greater than 700 nm. Thus, the collection of nanocrystals provides the desired absorbance spectrum of the optically-transparent material.

Suitable materials for the plasmonic nanocrystals include, without limitation, gold, silver, copper, aluminum, titanium nitride (TiN), indium tin oxide (ITO), and combinations thereof. The shapes of the nanocrystals include, without limitation, nanorods, nanostars, nanoshells, nanocups, and nanoprisms.

In an embodiment, the collection of plasmonic nanocrystals includes semiconductor and/or dielectric nanocrystals to block UV light. Semiconductor and dielectric nanocrystals (e.g., Si, ZnO, TiO₂, CdTe, etc.) are capable of strong absorption of UV light.

In certain embodiments of the filter, the defined wavelength range may be in the visible spectrum. And, in certain embodiments of the filter, the material may be glass or a polymer.

The material in which the collection of plasmonic nanocrystals is embedded may be a transparent film, such as a glass or polymer film. For example, the transparent material may be a glass pane. The composite glass can be used for home and cars. In another embodiment, a transparent conductor film is coated on a window to reflect IR light while permitting visible light to pass through the window. Composite polymer films can be used for packaging of food and drugs. For example, the composite polymer film will help to reduce the AC-system power consumption and increase the shelf-life of the food. Such transparent materials with the embedded collection of plasmonic nanocrystals may be used as external sheets exposed to open air that take solar-generated heat from the window via convection and heat diffusion.

Yet another aspect of the present invention, or other research or information related to the sphere of the invention, may provide a method of making a selective light wavelength filter. Such a method may include embedding a composition (such as any of those described above or elsewhere herein) in an optically-transparent composite material.

The following examples may provide further explanation of the described subject matter.

### EXAMPLES

### Example 1

In the study described in this Example 1, the plasmonic properties of aluminum and copper nanocups were experimentally and theoretically investigated. Copper nanocups were focused on, as they demonstrate stronger and sharper plasmon resonance peaks compared to their aluminum counterparts. Extinction spectra of the nanocups were measured with the nanocups dispersed in toluene or a mixture of toluene and acetic acid. An oxidation study was also carried out for the copper nanocups by measuring the extinction spectra in toluene immediately, 3 days, 7 days and 13 days after fabrication. A potential application for the copper nanocups is low emission window coatings. The replacement of commercial low emission window coatings containing one or multiple silver layers with copper nanocup mixtures may significantly reduce costs without sacrificing high performance.

Materials and Methods

In this Example 1, copper and aluminum nanocups were studied.

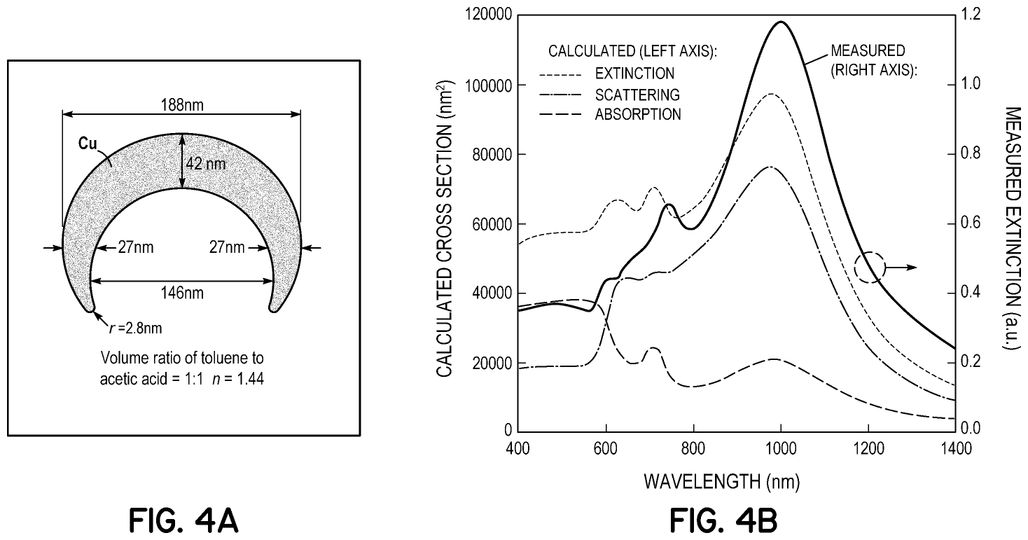

FIGS. 4A and 4B show the geometry model and extinction spectra of the copper nanocups dispersed in toluene and acetic acid. The background extinction below 600 nm is due to the interband transition of copper from the 3d band to the conduction band. Three plasmon resonance peaks can be observed around 600 nm, 740 nm, and 1000 nm. The calculated extinction spectra of the copper nanocups agree well with the measured spectra (FIG. 4B).

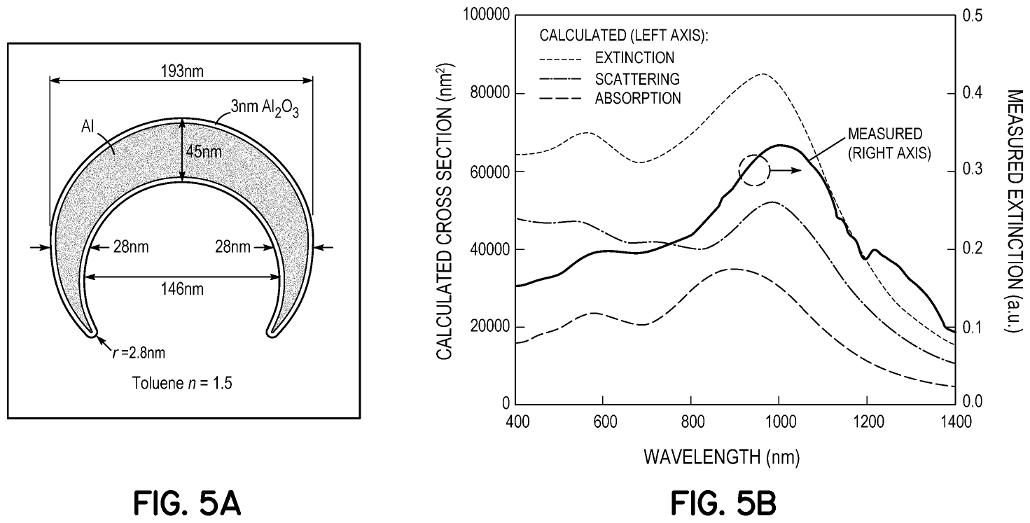

And, FIG. 5A shows the geometry model of the aluminum nanocups. FIG. 5B shows the extinction spectrum measured with the aluminum nanocups dispersed in toluene, and also the calculated extinction, scattering and absorption cross sections. Two plasmon resonance peaks around 580 nm and 990 nm can be observed. Again, the calculated extinction spectrum agrees well with the measured one.

Extinction spectra are measured for the nanocup dispersion using Cary 5000 UV-VIS-NIR spectrometer. Nanocups on an area of about 3.7 cm by 3.7 cm are used to prepare the dispersion for each extinction spectrum measurement. Oxidation studies for the copper nanocups are conducted by measuring the extinction spectra immediately, 3 days, 7 days, and 13 days after fabrication, respectively, in pure toluene. Unless otherwise specified, the extinction spectra reported in this Example 1 are the absolute values (not scaled).

The optical properties of copper and aluminum nanocups were numerically calculated using COMSOL® software. The sizes and shapes of the nanocups in the calculations were estimated from scanning electron microscopy (SEM) images and metal deposition rates on a bare wafer and fitted with the experimentally measured extinction spectra. A 3 nm Al₂O₃ layer was included around the aluminum nanocups to describe the unavoidable oxidation of aluminum [Martin, J.; Plain, J., J. Phys. D: Appl. Phys. 2014, 48, 184002]. The dielectric constants of copper and aluminum were taken respectively from Johnson, P. B. and Christy, R. W., Phys. Rev. B, 1972, 6, 4370, and Rakie, A. D., Appl. Opt., 1995, 34, 4755-4767. The refractive indices of the matrices are given by nₘₐₜᵣᵢₓ=1.44 (1:1 volume ratio of toluene to acetic acid) and nₘₐₜᵣᵢₓ=1.50 (toluene) for the copper nanocups and the aluminum nanocups, respectively. The refractive index of the Al₂O₃ oxide layer is given by n_{oxide}=1.76. The optical responses of the nanocups were calculated for different polarizations and wavevectors of light: {E∥z, k∥x}, {E∥z, k∥y}, {E∥x, k∥z}, {E∥y, k∥z}, {E∥y, k∥x}, {E∥x, k∥y}, where x, y are perpendicular to the nanocups axis and z is parallel to the nanocup axis. The final extinction spectra of the nanocups were averaged over the orientations.

Results and Discussion

Plasmonic Properties of Copper and Aluminum Nanocups

As mentioned above, FIGS. 4A and 4B show the geometry model and extinction spectra of the copper nanocups dispersed in toluene and acetic acid. The background extinction below 600 nm is due to the interband transition of copper from the 3d band to the conduction band. Three plasmon resonance peaks can be observed around 600 nm, 740 nm, and 1000 nm. The calculated extinction spectra of the copper nanocups agree well with the measured spectra (FIG. 4B).

FIG. 5A shows the geometry model of the aluminum nanocups. FIG. 5B shows the extinction spectrum measured with the aluminum nanocups dispersed in toluene, and also the calculated extinction, scattering and absorption cross sections. Two plasmon resonance peaks around 580 nm and 990 nm can be observed. Again, the calculated extinction spectrum agrees well with the measured one.

The excellent agreements between experimental and calculated extinction spectra found for both copper and aluminum nanocups validate the geometry model and suggest that the shapes of the nanocups are well-defined. Overall, the plasmon resonance peaks of the copper nanocups are much sharper and stronger than those of the aluminum nanocups. For this reason, the rest of the study of this Example 1 focused on copper nanocups.

Tuning Plasmon Resonance via Nanocup Shell Thickness

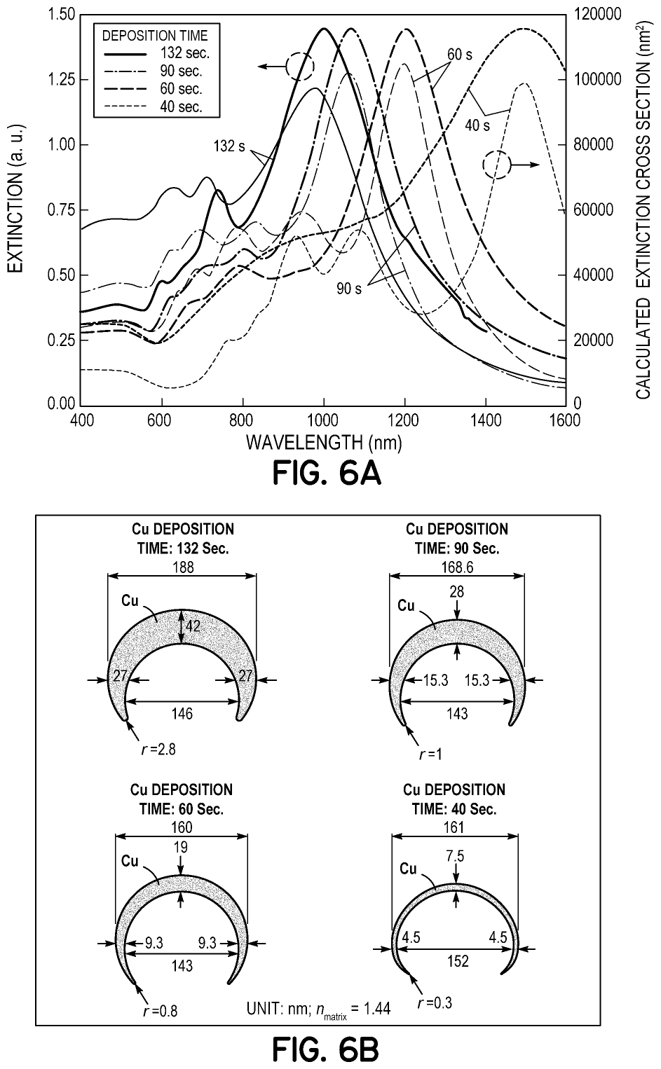

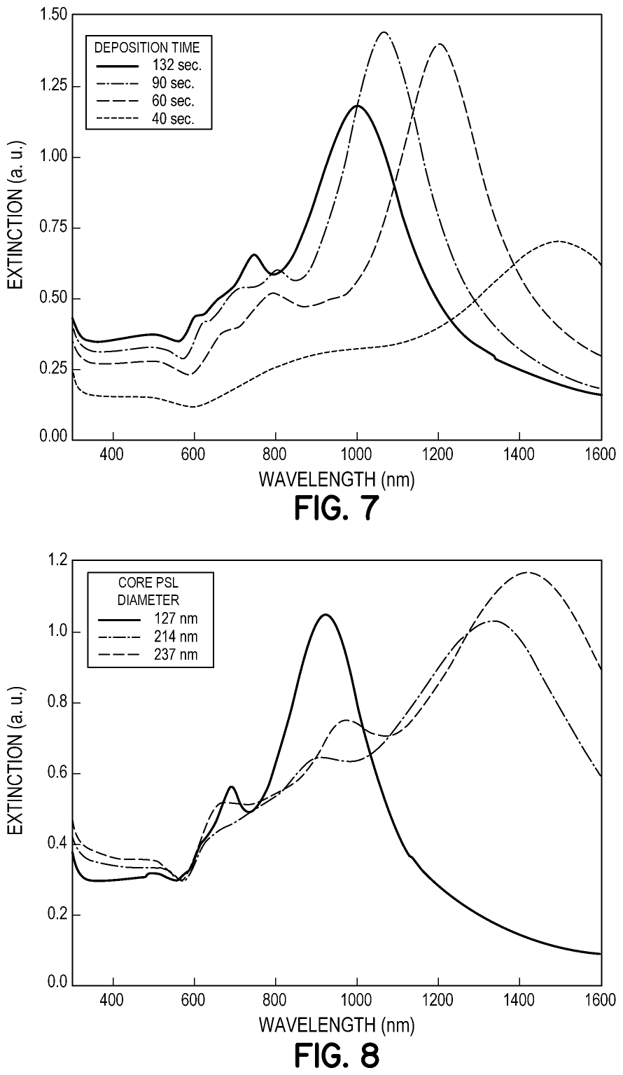

To tune the LSPR peaks of the copper nanocups, deposition time is varied between 40 sec to 132 sec, yielding copper nanocups of different shell thickness. Extinction spectra for copper nanocups with deposition times of 40 sec, 60 sec, 90 sec, and 132 sec, respectively, were measured in a mixture of toluene and acetic acid, shown as the solid curves in FIG. 6A. All of the four measured (solid) curves are scaled to the maximum of the dotted and dashed curve (90 sec deposition time) for easy comparison. Unscaled spectra can be seen in FIG. 7.

Tuning Plasmon Resonance via Core PSL Particle Size

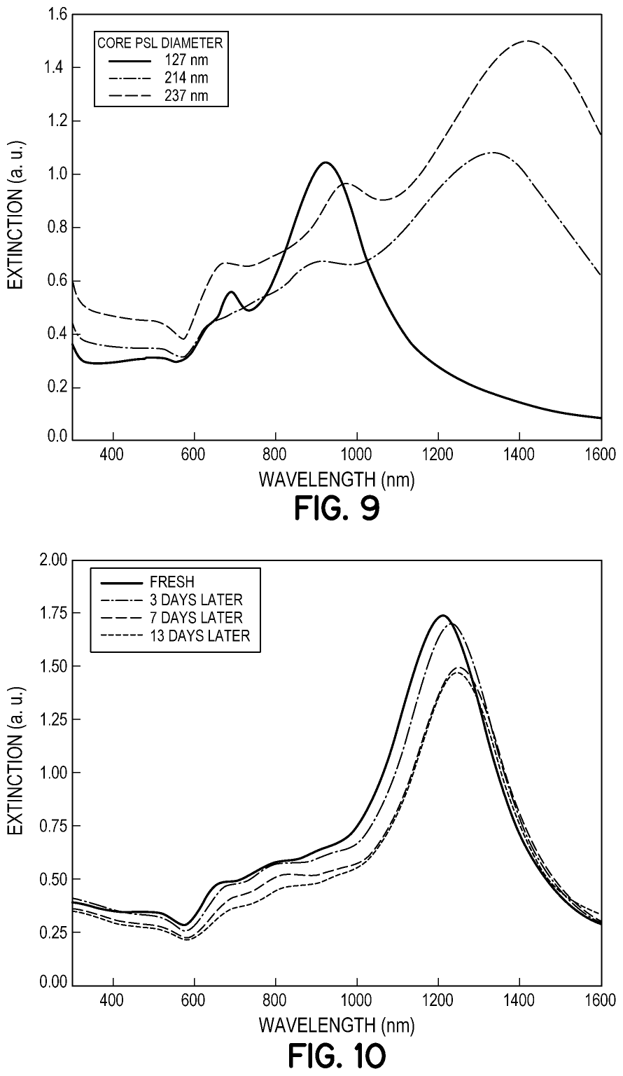

In addition to shell thickness, the LSPR peaks of the copper nanocups can also be tuned by varying the core PSL particle size. Copper nanocups are deposited on PSL templates of 3 different sizes, (127 nm, 214 nm, and 237 nm), with a deposition time of 132 sec. Extinction spectra of the nanocups dispersed in a 1:1 mixture of toluene and acetic acid are shown in FIG. 8. The dashed curve (237 nm) and the dashed and dotted curve (214 nm) are scaled down to the solid black curve (127 nm) for easy comparison. Unscaled spectra can be seen in FIG. 9. With increasing core PSL particle size, the main plasmon resonance peak red-shifts from ˜900 nm to 1400 nm.

Oxidation Study of Copper Nanocups

To study the oxidation and degradation of copper nanocups in air, extinction spectra are measured in toluene immediately, 3 days, 7 days, and 13 days after fabrication, shown in FIG. 10. Copper nanocups are deposited on an entire 4″ wafer for the oxidation study and for every extinction spectrum measurement, nanocups on an area of 3.7 cm by 3.7 cm are used to prepare a new dispersion. This helps to avoid multiple transfers of the nanocup dispersion between the measurement cuvette and the sonication vial that might be incomplete due to surface tension of the solvent. A new baseline from toluene is collected for each measurement to minimize the effects of cross-contamination from other materials stuck on the cuvette.

A minor red-shift and attenuation of the main LSPR peak at around 1200 nm is observed after 3 days. This allows plenty of time for the copper nanocups to be further processed in air for applications while their plasmonic properties remain almost the same. After 7 days, the red-shift and attenuation of the main LSPR peak becomes more noticeable. Note, however, that the peak intensity of the main LSPR peak at around 1200 nm compared to the background extinction below 600 nm and above 1600 nm is still greater than 10^{1.25} After 13 days, the main LSPR peak remains roughly the same as that after 7 days although the small features between 600 nm and 1000 nm see a minor decrease in intensity. A possible explanation is that the multipolar components of the plasmon resonances between 600 nm and 1000 nm are sensitive to slight changes of shell thickness and rim sharpness due to oxidation.

Potential Application: an Alternative to Low Emission Window Coatings

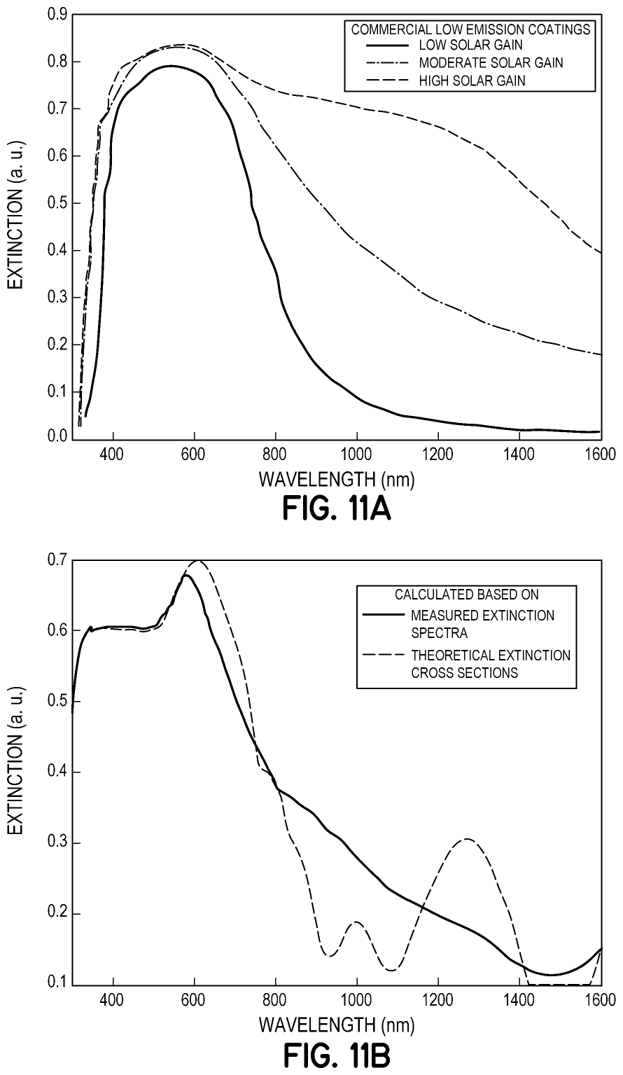

Based on the work described in the specification and the Example 1, one application for nanostructures, such as those described herein is window coatings. Currently, low emission windows are often an integral part of high performance commercial buildings. Multilayer structures comprised of metal, metal oxides, and metal nitrides are deposited on window glasses via physical vapor deposition. The number of layers in these multilayer coatings ranges from three to sometimes more than thirteen. Among those layers, one or more are often silver layers that help to reflect heat from the sun. Typical transmission spectra for low emission window coatings are shown in FIG. 11A (adapted from Carmody, J., Residential windows: a guide to new technologies and energy performance; WW Norton & Company, 2007).

With calculation, it was determined that transmission spectra somewhere in between those of moderate solar gain and low solar gain low emission coatings can be achieved with a mixture of copper nanocups at a low overall concentration. Specifically, a mixture of 90 sec, 60 sec, and 40 sec copper nanocups with a ratio of 0.1:0.1:1.3 yields the theoretical transmission spectrum shown as the solid curve in FIG. 11B. The numbers 0.1, 0.1, and 1.3 are relative concentrations of corresponding copper nanocups in reference to the amount used in the extinction spectra measurement shown in FIGS. 6A and 6B (nanocups on an area of about 3.7 cm by 3.7 cm dispersed in about 3 mL). In other words, the extinction spectra for each copper nanocup component is taken from FIGS. 6A and 6B and then multiplied by the numbers 0.1, 0.1, and 1.3 and converted to transmission. The overall transmission for the nanocup mixture is then obtained by multiplying the transmission for each nanocup component together. Alternatively, the transmission spectrum of the mixture can also be calculated by using calculated cross sections, shown as the dashed curve in FIG. 11B. For this calculation the transmittance of the nanocup mixture is written as:

T=exp(−Σσ_{ext,i}nᵢL)

Here σ_{ext,i} and nᵢ, are extinction cross section and the number density of the ith species respectively, and L is the path length of the beam. For the nanocups with deposition time of 90 sec, 60 sec, and 40 sec, the quantities nᵢL are estimated as 2.6×10⁸ cm⁻², 2.6×10⁸ cm⁻², and 3.4×10⁹ cm⁻², respectively. As seen, the transmission spectrum calculated based on the cross sections has consistent spectral features with the one calculated based on measured extinction spectra. Transmittance of the copper nanocup mixture from 800 nm to 1600 nm lies between those of moderate solar gain and low solar gain low emission coatings while the transmittance below 700 nm lies slightly (15%) below those of low emission coatings. Therefore, the replacement of multilayer coatings containing silver layers with copper nanocups may significantly reduce costs without sacrificing high window performance.

### Example 2

Advanced materials for optical applications are highly desirable in modern technology and industry. An important class of advanced materials includes optical media for windows, focusing lenses, and other related applications. Regarding window applications, one goal is to design an optically transparent and spectrally tailored medium that blocks infrared (IR) radiation [Carmody, J.; Selkowitz, S.; Heschong, L. Residential Windows: A Guide to New Technologies and Energy Performance, 1st. Ed.; Norton: New York, 1996]. The motivation for designing such IR-blocking windows lies in reducing the amount of heat radiatively transferred to a room or a vehicle, consequently reducing the energy consumed by AC or other active cooling systems.

There are several possible approaches for making spectrally selective windows. One approach entails covering a glass with a multilayered film that reflects IR light, while transmitting the visible part of the solar spectrum [Carmody, J.; Selkowitz, S.; Heschong, L. Residential Windows: A Guide to New Technologies and Energy Performance, 1st. Ed.; Norton: New York, 1996; Pacheco-Torgal, F. Eco-Efficient Materials for Mitigating Building Cooling Needs; Elsevier: Boston, Mass., 2015; Duffie, J. A.; Beckman, W. A. Solar Engineering of Thermal Processes, 4th Ed.; John Wiley: Hoboken, 2013; and Advances in Passive Cooling; Santamouris, M., Ed.; Buildings, energy, solar technology; Earthscan: London, 2007]. Another approach is to use near-IR interacting materials that can block most of the solar IR radiation [Nguyen, T. K. N.; Renaud, A.; Wilmet, M.; Dumait, N.; Paofai, S.; Dierre, B.; Chen, W.; Ohashi, N.; Cordier, S.; Grasset, F.; et al. New Ultra-Violet and near-Infrared Blocking Filters for Energy Saving Applications: Fabrication of Tantalum Metal Atom Cluster-Based Nanocomposite Thin Films by Electrophoretic Deposition. J Mater Chem C 2017, 5 (40), 10477-10484]. Along with glasses with static properties, much current interest is also directed to switchable glasses and windows [Baetens, R.; Jelle, B. P.; Gustaysen, A. Properties, Requirements and Possibilities of Smart Windows for Dynamic Daylight and Solar Energy Control in Buildings: A State-of-the-Art Review. Sol. Energy Mater. Sol. Cells 2010, 94 (2), 87-105; Wolfe, D.; Goossen, K. W. Evaluation of 3D Printed Optofluidic Smart Glass Prototypes. Opt. Express 2018, 26 (2), A85; and Haghanifar, S.; Gao, T.; Rodriguez De Vecchis, R. T.; Pafchek, B.; Jacobs, T. D. B.; Leu, P. W. Ultrahigh-Transparency, Ultrahigh-Haze Nanograss Glass with Fluid-Induced Switchable Haze. Optica 2017, 4 (12), 1522].

Certain requirements are imposed on such optical materials: good transmission in the visible range, strong attenuation in the near and short-wavelength IR, and strong reflection in the long-wavelength IR interval [Duffie, J. A.; Beckman, W. A. Solar Engineering of Thermal Processes, 4th Ed.; John Wiley: Hoboken, 2013; Advances in Passive Cooling; Santamouris, M., Ed.; Buildings, energy, solar technology; Earthscan: London, 2007; What When How. Window energy http://what-when-how.com/energy-engineering/window-energy/ (accessed Dec. 29, 2017); and Seven Sun Windows. Insulating Glass http://www.sevensunwindows.com/windows/replacement/glass (accessed Dec. 29, 2017)]. The latter is used to reflect nonsolar radiative heat coming from the street. So-called low-E (low emissivity) window panes are designed in this manner [Carmody, J.; Selkowitz, S.; Heschong, L. Residential Windows: A Guide to New Technologies and Energy Performance, 1st. Ed.; Norton: New York, 1996; Pacheco-Torgal, F. Eco-Efficient Materials for Mitigating Building Cooling Needs; Elsevier: Boston, Mass., 2015; What When How. Window energy http://what-when-how.com/energy-engineering/window-energy/ (accessed Dec. 29, 2017); Seven Sun Windows. Insulating Glass http://www.sevensunwindows.com/windows/replacement/glass (accessed Dec. 29, 2017); and Hammarberg, E.; Roos, A. Antireflection Treatment of Low-Emitting Glazings for Energy Efficient Windows with High Visible Transmittance. Thin Solid Films 2003, 442 (1-2), 222-226]. From the above three requirements, the decoupling of the visible and IR properties of a glass is desirable when seeking to create windows with high performance. A variety of resources (including online resources) provides useful introductions to the current practices and figures of merit employed in industrial settings [What When How. Window energy http://what-when-how.com/energy-engineering/window-energy/ (accessed Dec. 29, 2017); Seven Sun Windows. Insulating Glass http://www.sevensunwindows.com/windows/replacement/glass (accessed Dec. 29, 2017); and Glass Knowledge Blog. Non-solar heat control glasses https://theglassblog.wordpress.com/2011/02/06/non-solar-heat-control-glasses/ (accessed Dec. 29, 2017)].

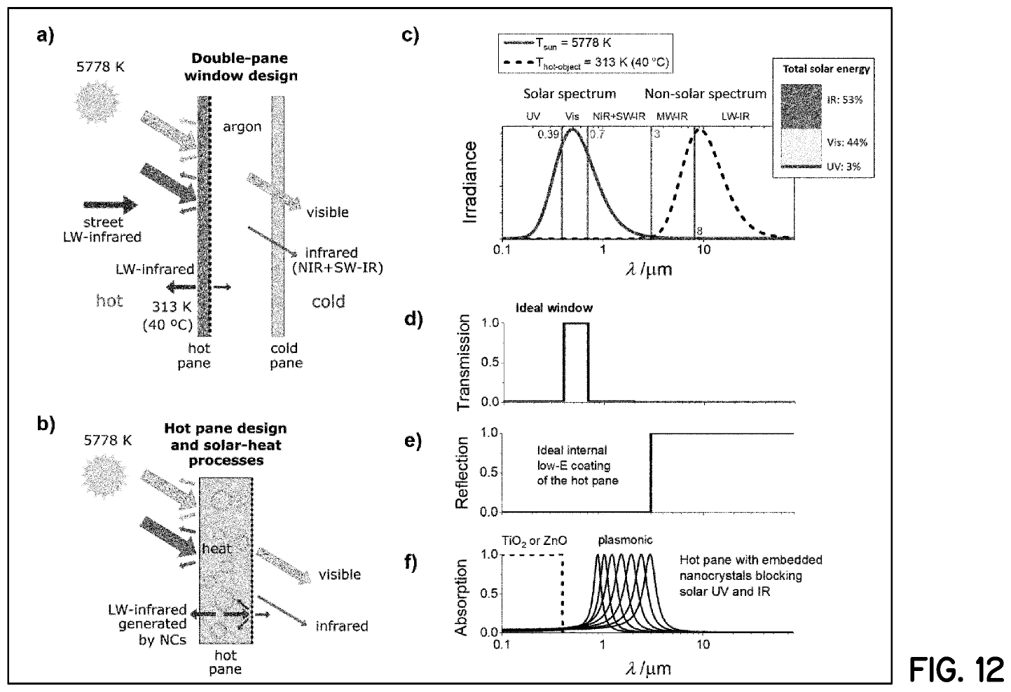

In this Example 2, an approach to create passive IR-blocking glasses using plasmonic nanocrystals is described. Mixtures of specially shaped plasmonic nanocrystals made of noble (Ag and Au) and alternative materials (TiN, Al, and Cu) are shown here to efficiently block IR solar radiation. In particular, nanocrystals of relatively inexpensive plasmonic materials (Ag, Cu, Al, and TiN) show an overall good performance as IR-blocking elements. In the approach of this Example 2, a metaglass incorporates a mixture of plasmonic nanocrystals (NCs) of different sizes. Because most individual NCs exhibit a narrow plasmonic band, a mixture of NCs can be selected to have a spectrum that efficiently covers the near-IR and short-wavelength IR intervals (FIG. 12, panel f). By adjusting the concentrations of NCs and taking suitable sizes, one can construct a broad extinction spectrum out of narrow plasmonic peaks (FIG. 12, panel f). The resulting medium is expected to block the IR light starting from wavelengths of 700 nm (FIG. 12, panel f).

Simultaneously, the metaglass should remain transparent in the visible. As shown herein, the most efficient shape for the NCs for the purpose herein is a complete nanoshell with relatively small width. This, however, does not limit the disclosure to complete nanoshells with relatively small width as being the only possible shape. Other possible NC shapes for high-performance glasses are nanorods and nanocups. Further, as it may be reasonable to expect, spherical NCs are not as useful for this purpose, because they do not offer sharp and easily controllable optical features. The reasons are that the plasmon resonance in spherical NCs is not very sensitive to its size, also becoming very broad for large NC; and that total material volume increases faster with the size of spherical geometries than with the largest dimension of the other geometries used in this study, leading to large intraband absorption, as well as interband absorption for some materials, near and inside the visible interval. The metaglass concept described herein includes the tunability of plasmonic resonances with the shape and size of a NC [Nguyen, T. K. N.; Renaud, A.; Wilmet, M.; Dumait, N.; Paofai, S.; Dierre, B.; Chen, W.; Ohashi, N.; Cordier, S.; Grasset, F.; et al. New Ultra-Violet and near-Infrared Blocking Filters for Energy Saving Applications: Fabrication of Tantalum Metal Atom Cluster-Based Nanocomposite Thin Films by Electrophoretic Deposition. J Mater Chem C 2017, 5 (40), 10477-10484; Maier, S. A. Plasmonics: Fundamentals and Applications; Springer: New York, 2007; Complex-Shaped Metal Nanoparticles: Bottom-up Syntheses and Applications; Murphy, C. J., Sau, T. K., Rogach, A. L., Eds.; Wiley-VCH: Weinheim, 2012; Haynes, C. L.; Van Duyne, R. P. Nanosphere Lithography: A Versatile Nanofabrication Tool for Studies of Size-Dependent Nanoparticle Optics. J. Phys. Chem. B 2001, 105 (24), 5599-5611; Joplin, A.; Chang, W.-S.; Link, S. Imaging and Spectroscopy of Single Metal Nanostructure Absorption. Langmuir 2017; Prodan, E.; Radloff, C.; Halas, N. J.; Nordlander, P. A Hybridization Model for the Plasmon Response of Complex Nanostructures. Science 2003, 302 (5644), 419-422; Blaber, M. G.; Arnold, M. D.; Ford, M. J. Search for the Ideal Plasmonic Nanoshell: The Effects of Surface Scattering and Alternatives to Gold and Silver. J. Phys. Chem. C 2009, 113 (8), 3041-3045; Ye, J.; Verellen, N.; Van Roy, W.; Lagae, L.; Maes, G.; Borghs, G.; Van Dorpe, P. Plasmonic Modes of Metallic Semishells in a Polymer Film. ACS Nano 2010, 4 (3), 1457-1464; Van Dorpe, P.; Ye, J. Semishells: Versatile Plasmonic Nanoparticles. ACS Nano 2011, 5 (9), 6774-6778; Frederiksen, M.; Bochenkov, V. E.; Cortie, M. B.; Sutherland, D. S. Plasmon Hybridization and Field Confinement in Multilayer Metal-Dielectric Nanocups. J. Phys. Chem. C 2013, 117 (30), 15782-15789; and Qin, Y.; Kong, X.-T.; Wang, Z.; Govorov, A. O.; Kortshagen, U. R. Near-Infrared Plasmonic Copper Nanocups Fabricated by Template-Assisted Magnetron Sputtering. ACS Photonics 2017, 4 (11), 2881-2890].

In particular, it is known from the literature that plasmonic nanoshells and nanocups have shown excellent tunability of their plasmon resonances [Prodan, E.; Radloff, C.; Halas, N. J.; Nordlander, P. A Hybridization Model for the Plasmon Response of Complex Nanostructures. Science 2003, 302 (5644), 419-422; Blaber, M. G.; Arnold, M. D.; Ford, M. J. Search for the Ideal Plasmonic Nanoshell: The Effects of Surface Scattering and Alternatives to Gold and Silver. J. Phys. Chem. C 2009, 113 (8), 3041-3045; Ye, J.; Verellen, N.; Van Roy, W.; Lagae, L.; Maes, G.; Borghs, G.; Van Dorpe, P. Plasmonic Modes of Metallic Semishells in a Polymer Film. ACS Nano 2010, 4 (3), 1457-1464; Van Dorpe, P.; Ye, J. Semishells: Versatile Plasmonic Nanoparticles. ACS Nano 2011, 5 (9), 6774-6778; Frederiksen, M.; Bochenkov, V. E.; Cortie, M. B.; Sutherland, D. S. Plasmon Hybridization and Field Confinement in Multilayer Metal-Dielectric Nanocups. J. Phys. Chem. C 2013, 117 (30), 15782-15789; Qin, Y.; Kong, X.-T.; Wang, Z.; Govorov, A. O.; Kortshagen, U. R. Near-Infrared Plasmonic Copper Nanocups Fabricated by Template-Assisted Magnetron Sputtering. ACS Photonics 2017, 4 (11), 2881-2890; and Wang, H.; Wu, Y.; Lassiter, B.; Nehl, C. L.; Hafner, J. H.; Nordlander, P.; Halas, N. J. Symmetry Breaking in Individual Plasmonic Nanoparticles. Proc. Natl. Acad. Sci. 2006, 103 (29), 10856-10860].

The usefulness of plasmonic NCs as building elements for metaglasses lies in their very large absorption and scattering cross sections and in their narrow and tunable plasmonic resonances. The current literature offers several approaches to construct media with strong optical absorption. Broadband metamaterial absorbers can be made using a layer of plasmonic nanocrystals placed above a metal film [Hedayati, M. K.; Javaherirahim, M.; Mozooni, B.; Abdelaziz, R.; Tavassolizadeh, A.; Chakravadhanula, V. S. K.; Zaporojtchenko, V.; Strunkus, T.; Faupel, F.; Elbahri, M. Design of a Perfect Black Absorber at Visible Frequencies Using Plasmonic Metamaterials. Adv. Mater. 2011, 23 (45), 5410-5414; and Chen, X.; Gong, H.; Dai, S.; Zhao, D.; Yang, Y.; Li, Q.; Qiu, M. Near-Infrared Broadband Absorber with Film-Coupled Multilayer Nanorods. Opt. Lett. 2013, 38 (13), 2247]. Because of their two-layer geometry, such absorbers are optically ultrathin structures. Optical absorbers and spectral filters can be also designed utilizing the Beer-Lambert law [Qin, Y.; Kong, X.-T.; Wang, Z.; Govorov, A. O.; Kortshagen, U. R. Near-Infrared Plasmonic Copper Nanocups Fabricated by Template-Assisted Magnetron Sputtering. ACS Photonics 2017, 4 (11), 2881-2890; Hashimura, A.; Tweet, D.; Hinch, G.; Koposov, A. Energy-Efficient Transparent Solar Film. US9091812B2; Zhang, H.; Demir, H. V.; Govorov, A. O. Plasmonic Metamaterials and Nanocomposites with the Narrow Transparency Window Effect in Broad Extinction Spectra. ACS Photonics 2014, 1 (9), 822-832; Besteiro, L. V.; Gungor, K.; Demir, H. V.; Govorov, A. O. Simple and Complex Metafluids and Metastructures with Sharp Spectral Features in a Broad Extinction Spectrum: Particle-Particle Interactions and Testing the Limits of the Beer-Lambert Law. J. Phys. Chem. C 2017, 121 (5), 2987-2997; and Yang, J.; Kramer, N. J.; Schramke, K. S.; Wheeler, L. M.; Besteiro, L. V.; Hogan, C. J.; Govorov, A. O.; Kortshagen, U. R. Broadband Absorbing Exciton-Plasmon Metafluids with Narrow Transparency Windows. Nano Lett. 2016, 16 (2), 1472-1477]. In this case, the structures are optically thick and should be considered as films or electromagnetic media. Creating such media with embedded, randomly dispersed nanocrystals, one can obtain transparency windows in the visible and IR intervals [Qin, Y.; Kong, X.-T.; Wang, Z.; Govorov, A. O.; Kortshagen, U. R. Near-Infrared Plasmonic Copper Nanocups Fabricated by Template-Assisted Magnetron Sputtering. ACS Photonics 2017, 4 (11), 2881-2890; Hashimura, A.; Tweet, D.; Hinch, G.; Koposov, A. Energy-Efficient Transparent Solar Film. US9091812B2; Zhang, H.; Demir, H. V.; Govorov, A. O. Plasmonic Metamaterials and Nanocomposites with the Narrow Transparency Window Effect in Broad Extinction Spectra. ACS Photonics 2014, 1 (9), 822-832; Besteiro, L. V.; Gungor, K.; Demir, H. V.; Govorov, A. O. Simple and Complex Metafluids and Metastructures with Sharp Spectral Features in a Broad Extinction Spectrum: Particle-Particle Interactions and Testing the Limits of the Beer-Lambert Law. J. Phys. Chem. C 2017, 121 (5), 2987-2997; and Yang, J.; Kramer, N. J.; Schramke, K. S.; Wheeler, L. M.; Besteiro, L. V.; Hogan, C. J.; Govorov, A. O.; Kortshagen, U. R. Broadband Absorbing Exciton-Plasmon Metafluids with Narrow Transparency Windows. Nano Lett. 2016, 16 (2), 1472-1477]. One particular optical feature modeled and experimentally realized in Zhang, H.; Demir, H. V.; Govorov, A. O. Plasmonic Metamaterials and Nanocomposites with the Narrow Transparency Window Effect in Broad Extinction Spectra. ACS Photonics 2014, 1 (9), 822-832; Besteiro, L. V.; Gungor, K.; Demir, H. V.; Govorov, A. O. Simple and Complex Metafluids and Metastructures with Sharp Spectral Features in a Broad Extinction Spectrum: Particle-Particle Interactions and Testing the Limits of the Beer-Lambert Law. J. Phys. Chem. C 2017, 121 (5), 2987-2997; and Yang, J.; Kramer, N. J.; Schramke, K. S.; Wheeler, L. M.; Besteiro, L. V.; Hogan, C. J.; Govorov, A. O.; Kortshagen, U. R. Broadband Absorbing Exciton-Plasmon Metafluids with Narrow Transparency Windows. Nano Lett. 2016, 16 (2), 1472-1477 was a narrow transparency window in the IR.

In this Example 2, the focus is on another application and another optical material system, a metaglass featuring an IR-blocking steplike spectrum. One goal of the present study described in this Example is to design an efficient metaglass for passive energy-saving windows. This kind of approach stands in contrast with devices which exhibit tunable transmission profiles, such as electrochromic windows [Baetens, R.; Jelle, B. P.; Gustaysen, A. Properties, Requirements and Possibilities of Smart Windows for Dynamic Daylight and Solar Energy Control in Buildings: A State-of-the-Art Review. Sol. Energy Mater. Sol. Cells 2010, 94 (2), 87-105; Llordés, A.; Garcia, G.; Gazquez, J.; Milliron, D. J. Tunable Near-Infrared and Visible-Light Transmittance in Nanocrystal-in-Glass Composites. Nature 2013, 500 (7462), 323-326; Granqvist, C. G. Electrochromics for Smart Windows: Oxide-Based Thin Films and Devices. Thin Solid Films 2014, 564, 1-38; and Runnerstrom, E. L.; Llordés, A.; Lounis, S. D.; Milliron, D. J. Nanostructured Electrochromic Smart Windows: Traditional Materials and NIR-Selective Plasmonic Nanocrystals. Chem Commun 2014, 50 (73), 10555-10572].

Although passive glasses lack the flexibility that these active solutions provide, their transmission profile can be closely tuned to the specific needs of the system, and they are in general a cheaper, longer-lived, and simpler to fabricate alternative. These characteristics can facilitate a wider adoption of this technology, and so the study of this Example provides an avenue to further reduce the cost of these devices, while maintaining their desirable optical properties. In addition, active devices can be built using plasmonic systems, so that our approach can potentially be adapted into designs with controllable optical properties [Runnerstrom, E. L.; Llordés, A.; Lounis, S. D.; Milliron, D. J. Nanostructured Electrochromic Smart Windows: Traditional Materials and NIR-Selective Plasmonic Nanocrystals. Chem Commun 2014, 50 (73), 10555-10572; and De Sio, L.; Caputo, R.; Cataldi, U.; Umeton, C. Broad Band Tuning of the Plasmonic Resonance of Gold Nanoparticles Hosted in Self-Organized Soft Materials. J. Mater. Chem. 2011, 21 (47), 18967].

Physical Principles of Blocking Solar and Nonsolar IR Radiation.

FIG. 12 illustrates the principles followed to create a window that simultaneously blocks IR solar radiation and does not allow nonsolar heat from the outside and from the hot pane to penetrate a cold space. As mentioned near the beginning of this Example, decoupling the electromagnetic properties in the visible range and in the IR intervals is desirable [Carmody, J.; Selkowitz, S.; Heschong, L. Residential Windows: A Guide to New Technologies and Energy Performance, 1st. Ed.; Norton: New York, 1996; Pacheco-Torgal, F. Eco-Efficient Materials for Mitigating Building Cooling Needs; Elsevier: Boston, Mass., 2015; Duffie, J. A.; Beckman, W. A. Solar Engineering of Thermal Processes, 4th Ed.; John Wiley: Hoboken, 2013; Advances in Passive Cooling; Santamouris, M., Ed.; Buildings, energy, solar technology; Earthscan: London, 2007; What When How. Window energy http://what-when-how.com/energy-engineering/window-energy/ (accessed Dec. 29, 2017); and Seven Sun Windows. Insulating Glass http://www.sevensunwindows.com/windows/replacement/glass (accessed Dec. 29, 2017)]. Therefore, three distinct spectral intervals should be considered: visible (Vis, 390-700 nm), near-IR and short-wavelength IR (NIR and SW-IR; 0.7-3 μm), and midwavelength and long-wavelength IR (MW-IR and LW-IR; 3-15 μm).

The sun radiates mostly in the Vis, NIR and SW-IR intervals, as in FIG. 12, panel c, which shows the fractions of solar energy that falls in the different intervals. This figure also demonstrates why the IR interval may have some degree of importance in solar heating: it contributes a 53% of the total radiated energy, versus only a 44% from the visible interval. Of course, the visible radiation also carries energy inside a cold room, but it is desirable to provide illumination which is friendly to the human eye. In window technologies, two types of radiation are considered, solar and nonsolar [Carmody, J.; Selkowitz, S.; Heschong, L. Residential Windows: A Guide to New Technologies and Energy Performance, 1st. Ed.; Norton: New York, 1996; Duffie, J. A.; Beckman, W. A. Solar Engineering of Thermal Processes, 4th Ed.; John Wiley: Hoboken, 2013; and Glass Knowledge Blog. Non-solar heat control glasses https://theglassblog.wordpress.com/2011/02/06/non-solar-heat-control-glasses/ (accessed Dec. 29, 2017)]. Nonsolar heat on a hot day comes from all heated objects around a building and their associated radiation spectrum corresponds to that of a blackbody spectrum at a temperature of ˜40° C. (FIG. 12, panel c) and to a characteristic wavelength of ˜10 μm (LW-IR interval).

One possible window design capable of blocking both solar and nonsolar thermal radiation (FIG. 12, panel a) is a double-pane argon-filled window with an absorbing external pane [Carmody, J.; Selkowitz, S.; Heschong, L. Residential Windows: A Guide to New Technologies and Energy Performance, 1st. Ed.; Norton: New York, 1996; Pacheco-Torgal, F. Eco-Efficient Materials for Mitigating Building Cooling Needs; Elsevier: Boston, Mass., 2015; What When How. Window energy http://what-when-how.com/energy-engineering/window-energy/ (accessed Dec. 29, 2017)]. In this design, the outside pane strongly extinguishes solar IR radiation, yet effectively transmits visible light. The panes are separated by argon gas, which has a low thermal conductivity and low convection. Visible solar light (44% of radiated solar energy) penetrates well into the room, while IR solar radiation (53%) is strongly attenuated by the outside pane. The plasmonic NCs used in this study can be integrated into this design by embedding them into a suitable transparent dielectric medium, such as glass or polymer. This plasmonic layer can either represent the full thickness of the outer pane, or just a coating applied to a glass pane. Because the outside pane absorbs IR photons, it heats up and radiates energy as a blackbody at ˜40° C. This radiation should not move into the cold room and, therefore, one could add a coating to reflect the MW-IR and LW-IR radiation with wavelengths >3 μm. This coating may be placed in the internal surface of the outside pane (see FIG. 12, panels a and b), and may be applied using a thin transparent conducting film (typically, indium tin oxide or similar) [Carmody, J.; Selkowitz, S.; Heschong, L. Residential Windows: A Guide to New Technologies and Energy Performance, 1st. Ed.; Norton: New York, 1996; Pacheco-Torgal, F. Eco-Efficient Materials for Mitigating Building Cooling Needs; Elsevier: Boston, Mass., 2015; and Hammarberg, E.; Roos, A. Antireflection Treatment of Low-Emitting Glazings for Energy Efficient Windows with High Visible Transmittance. Thin Solid Films 2003, 442 (1-2), 222-226]. In other words, this transparent coating aims to reflect solar and nonsolar thermal radiation (MW- and LW-IR) in the window system (see FIG. 12, panels a-c and e).

By definition, solar energy is the energy coming as direct radiation from the sun. The sun's spectrum is well represented by a blackbody at its surface temperature Tₛᵤₙ=5778 K,

$$\frac{dI}{d λ} = {I}_{solar} ( λ ) \\ {I}_{solar} ( λ ) = \frac{{A}_{s}}{{λ}^{5}} \frac{1}{{e}^{\frac{hc}{λ {kT}_{sun}}} - 1} \qquad ( 1 )$$

where I is the solar energy flux, Iₛₒₗₐᵣ(λ) is the related spectral function, h is Planck's constant, c is the speed of light in vacuum, k is Boltzmann's constant, and Aₛ is an empirical constant determined by measuring the total sun energy flux at sea level. Another temperature relevant for this system is that of immediate environment on a hot day. For purposes of this Example 2, it is assumed that this temperature is ˜40° C. Correspondingly, the thermal radiation (nonsolar) from hot outside objects has the spectrum

$${I}_{non \text{-} solar} ( λ ) = \frac{{A}_{ns}}{{λ}^{5}} \frac{1}{{e}^{\frac{hc}{λ {kT}_{hot \text{-} day}}} - 1} , {T}_{hot \text{-} day} = 313 K$$

Next, the figures of merit of glasses, as used in industry, are introduced [Pacheco-Torgal, F. Eco-Efficient Materials for Mitigating Building Cooling Needs; Elsevier: Boston, Mass., 2015; Advances in Passive Cooling; Santamouris, M., Ed.; Buildings, energy, solar technology; Earthscan: London, 2007; Seven Sun Windows. Insulating Glass http://www.sevensunwindows.com/windows/replacement/glass (accessed Dec. 29, 2017); and Hammarberg, E.; Roos, A. Antireflection Treatment of Low-Emitting Glazings for Energy Efficient Windows with High Visible Transmittance. Thin Solid Films 2003, 442 (1-2), 222-226]. The first of these is visible transmittance (VT). This parameter is the fraction of visible light that enters a room through a window

$$VT = \frac{{{\int }_{390 nm}}^{700 nm} {I}_{solar} ( λ ) T ( λ ) d λ}{{{\int }_{390 nm}}^{700 nm} {I}_{solar} ( λ ) d λ} \qquad ( 2 )$$

where T(λ) is the optical transmittance of the window. The next parameter is the IR transmittance (IRT)

$$IRT = \frac{{{\int }_{700 nm}}^{1700 nm} {I}_{solar} ( λ ) T ( λ ) d λ}{{{\int }_{700 nm}}^{1700 nm} {I}_{solar} ( λ ) d λ} \qquad ( 3 )$$

And the total energy transmittance of the window for direct solar illumination will be given by the parameter called solar heat gain coefficient (SHGC)

$$SHGC = \frac{{{\int }_{200 nm}}^{1700 nm} {I}_{solar} ( λ ) T ( λ ) d λ}{{{\int }_{200 nm}}^{1700 nm} {I}_{solar} ( λ ) d λ} \qquad ( 4 )$$

In industry, this parameter includes radiative and non-radiative transfers of heat created by direct sun flux. Here, the focus is on the optical properties and, for simplicity, this parameter is calculated through the optical transmission.

To have a useful window, the parameter VT should be as high as possible, because a cold room should still receive visible solar light; a perfect window with ideal transmission of the visible has VT_{ideal}=1. Simultaneously, a perfect window should have IRT_{ideal}=0. In the following, the above figures of merit will be examined for the new plasmonic metaglasses designed here, and comparisons with commercial materials will be offered. An ideal window should have a transmission T(λ)=1 for the visible light and T(λ)=0 outside the visible interval, which results in SHGC_{ideal}=0.43 for the given integration interval in the equations. In real windows, one would aim to have the parameters SHGC and, specially, IRT as small as possible, in order to keep the room cool.

In the above integrals (i.e., equations 2-4), the following limits of integration were adapted: 200 nm-1700 nm. This is a wavelength range for which there is reliable information on the different materials' dielectric constants. This range includes most of the UV portion of the solar spectrum and values from the IR tail up to 10% of the maximum irradiance, resulting in a reliable approximation to the total solar energy spectrum, especially when accounting for the atmospheric absorption of sunlight. To address the UV part of the spectrum, TiO₂ NCs were added to the metafilms, which strongly blocks the UV interval.

Models of Plasmonic Metafilms Based on the Beer-Lambert Law.

The transmittance of a mixture of NCs for direct (ballistic) incident photons in a transparent matrix is given by

$${T}_{dir} = \frac{{I}_{t}}{{I}_{i}} = {10}^{- OD} = {e}^{- {OD}_{e}} \qquad ( 5 )$$

where Iᵢ and Iₜ are the incident and transmitted intensities, respectively. The Beer-Lambert law [Ingle, J. D.; Crouch, S. R. Spectrochemical Analysis; Prentice Hall: Englewood Cliffs, N.J, 1988] states that the optical density OD can be calculated as

$$OD = \frac{{L}_{opt}}{ln ( 10 )} {\sum }_{i} {σ}_{i} {n}_{i} , {OD}_{e} = {L}_{opt} {\sum }_{i} {σ}_{i} {n}_{i} \qquad ( 6 )$$

where Lₒₚₜ is the optical path that the light traverses through the metafilm with embedded NCs. The sum index runs through the different types of NCs in an ensemble, and nᵢ and σᵢ are the number concentration and the extinction cross section of the ith species, respectively. Because individual NCs in a metafilm are generally anisotropic, the optical extinction σᵢ used in equation 6 should be averaged over all orientations of a NC relative to the incident light. The extinction is composed of two contributions, σᵢ=σ_{i,s}++σ_{i,a}, where the terms are the scattering and absorption cross sections, respectively.

The electrodynamic calculations that provide the NC extinction data reported herein have been performed by solving Maxwell's equations within a classical framework. In particular, the commercial package COMSOL® was used, based on the Finite Elements Method. Cross sections of individual NCs were averaged from the set of directional extinctions calculated for six different illumination conditions (along the three main axes and involving two orthogonal linear polarizations of incident light). Then, these averaged cross sections were used in equation 6 to calculate the optical density and the transmission.

Local dielectric constants for the materials of interest were taken from the following sources: Johnson, P. B.; Christy, R. W. Optical Constants of the Noble Metals. Phys. Rev. B 1972, 6 (12), 4370 for Au, Ag, and Cu; Rakić, A. D. Algorithm for the Determination of Intrinsic Optical Constants of Metal Films: Application to Aluminum. Appl. Opt. 1995, 34 (22), 4755 for Al; and Guler, U.; Kildishev, A.; Boltasseva, A.; Shalaev, V. FD 178: Plasmonics on the Slope of Enlightenment: The Role of Transition Metal Nitrides. Faraday Discuss 2014 for TiN.

An underlying assumption for this approach to creating media with an engineered transparency profile is that the individual NCs are sufficiently separated from each other so that their excitation modes are not hybridized through near-field interaction, which would affect their optical profiles and distort the general transmission profile. Although the overall effect can be obtained even at relatively small interparticle distances [Besteiro, L. V.; Gungor, K.; Demir, H. V.; Govorov, A. O. Simple and Complex Metafluids and Metastructures with Sharp Spectral Features in a Broad Extinction Spectrum: Particle-Particle Interactions and Testing the Limits of the Beer-Lambert Law. J. Phys. Chem. C 2017, 121 (5), 2987-2997], measures should be taken to avoid NC aggregation, as it would affect and potentially impede the creation of the intended transmission profile [Besteiro, L. V.; Gungor, K.; Demir, H. V.; Govorov, A. O. Simple and Complex Metafluids and Metastructures with Sharp Spectral Features in a Broad Extinction Spectrum: Particle-Particle Interactions and Testing the Limits of the Beer-Lambert Law. J. Phys. Chem. C 2017, 121 (5), 2987-2997; and Yang, J.; Kramer, N. J.; Schramke, K. S.; Wheeler, L. M.; Besteiro, L. V.; Hogan, C. J.; Govorov, A. O.; Kortshagen, U. R. Broadband Absorbing Exciton-Plasmon Metafluids with Narrow Transparency Windows. Nano Lett. 2016, 16 (2), 1472-1477].

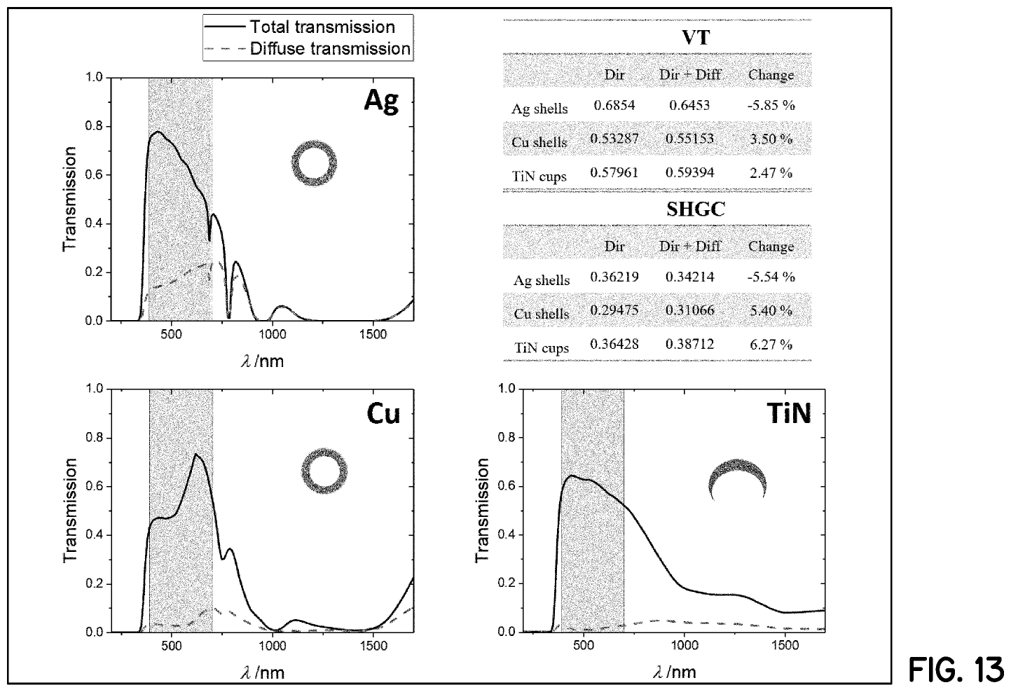

The above formalism is based on the Beer-Lambert law, which takes into account the extinction of ballistic photons from sun rays. Part of this extinction is due to nanoparticle scattering, which can represent a sizable contribution for large NCs, and opens up the possibility that scattered photons end up traversing the metaglass and entering into the room. The fluxes of diffusive photons crossing the right surface of the glass was therefore calculated. The effect of photon diffusion for all the best performing plasmonic glasses does not affect the conclusions herein. For example, the change in the central figures of merit (VT and SHGC) does not exceed 6% by taking diffusion into account when optimizing the high-performing glasses with Ag- and Cu-nanoshell plasmonic media (as compared with considering only direct transmission when optimizing their composition, see the table in FIG. 13). The physical reasons for the effect of diffusion not being overall very strong are the following: (1) in the visible interval, the present glasses are transparent and the scattering is weak; furthermore, in this spectral interval, the scattering and diffusion of photons play a positive role, increasing the figure of merit VT; (2) In the IR interval, the mean free path of a photon becomes much shorter than the glass thickness and, therefore, the diffusive photons become localized near the left surface. Then, these photons mostly diffuse outside through the left surface or become absorbed by the plasmonic medium. In the Supporting Information section of this Example 2 (below), such radiation diffusion processes for both visible and IR intervals are described. The total transmission will include the contribution of the diffused photons, as

T=T_{dir}+T_{diff} (7)

where T_{dir} and T_{diff} are, respectively, the direct light transmission given by equation 5 and the diffusive-light transmission described in the Supporting Information section (below).

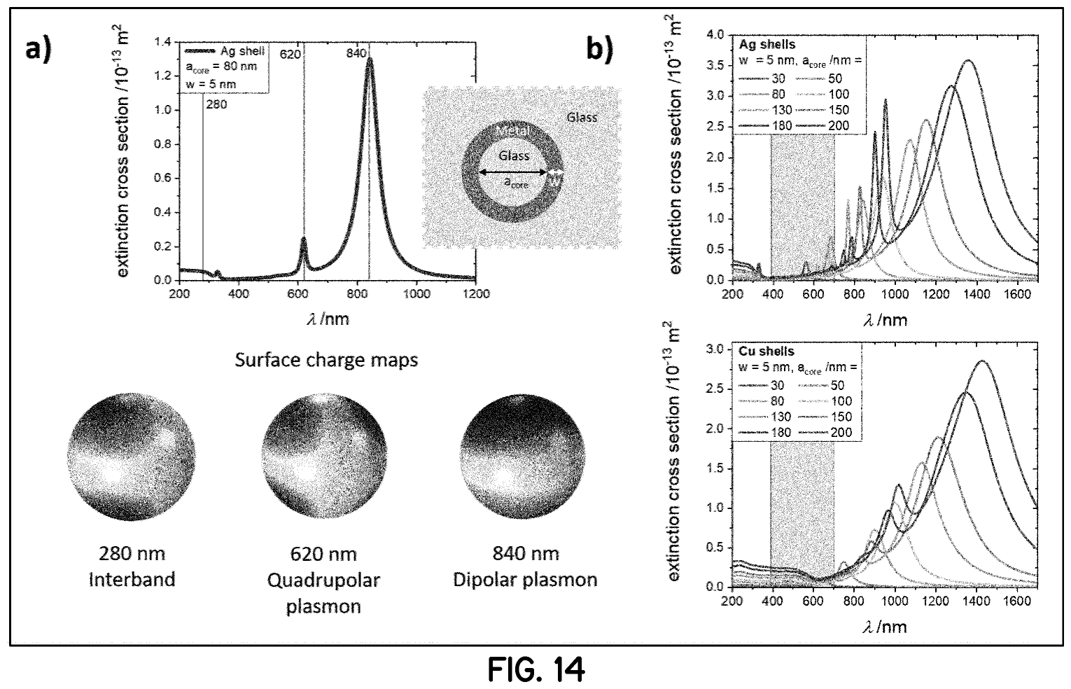

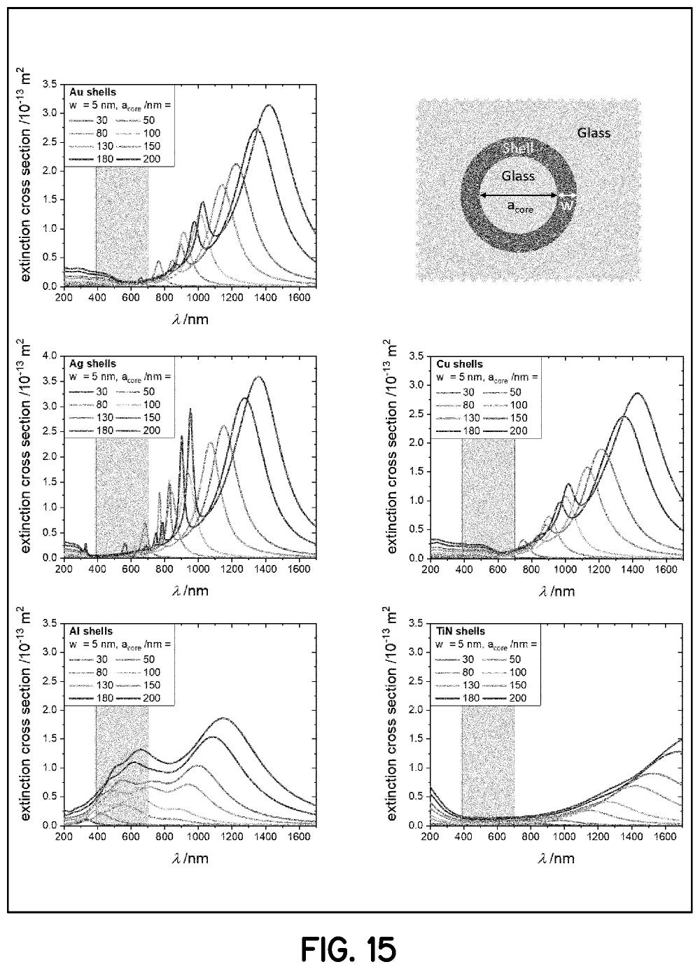

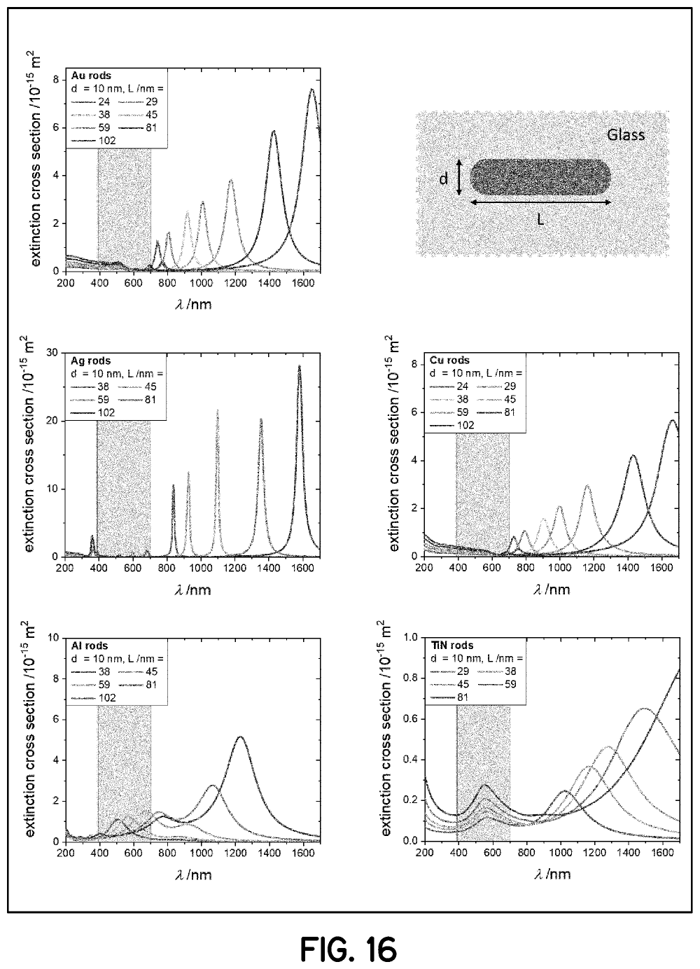

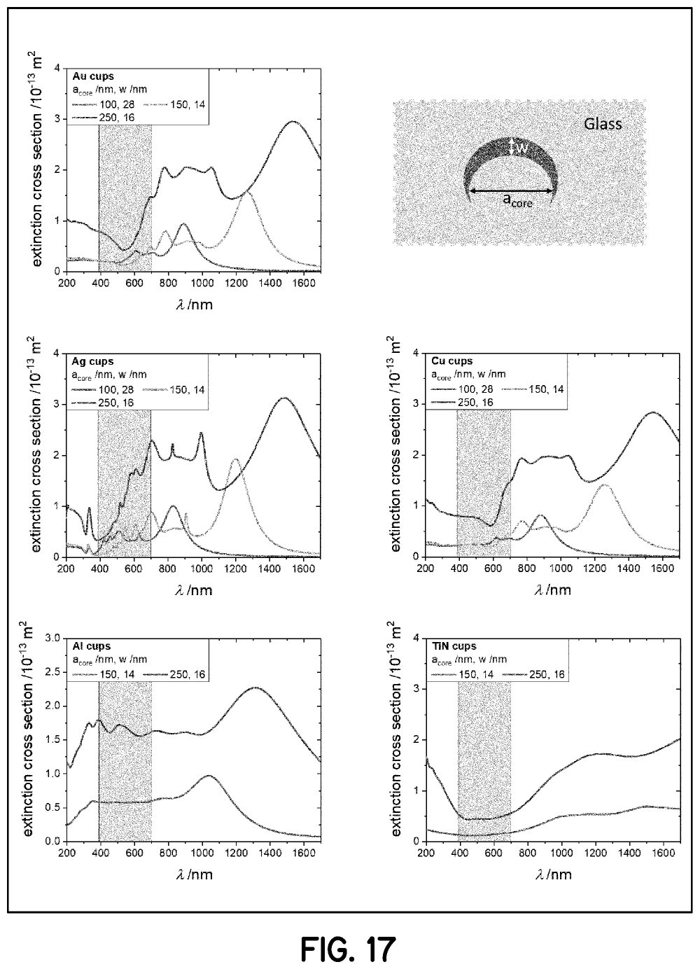

In this study, two methods are employed to find sets of nanocrystal densities that efficiently create an energy-saving glass: (1) A direct manual optimization guided by the NCs' extinction profiles (FIG. 14, panel b, and FIGS. 15, 16, and 17) and (2) a computer optimization. In the optimization process, sets of nanocrystals with geometrical parameters that are consistent with available experimental reports are used. As expected, the two methods above give overall similar results, because the optimization problem is relatively simple and, therefore, the manual optimization is efficient. The computer optimization is performed by minimizing the ideality parameter (IP), which provides a metric for the spectral difference between a given transmission profile and the target or ideal profile

$$IP = \frac{{{\int }_{200 nm}}^{1700 nm} {( T ( λ ) - {T}_{ideal} ( λ ) )}^{2} d λ}{{{\int }_{200 nm}}^{1700 nm} d λ} \qquad ( 8 )$$

where T_{ideal}(λ) is the transmission of an ideal glass (FIG. 12, panel d): T_{ideal}=1 for the visible (390 nm<λ<700 nm) and T_{ideal}=0 for the UV and IR intervals (λ<390 or λ>700 nm). The computer optimization algorithm used herein is described in detail in the Supporting Information section of this Example (below). However, this study does not aim to perform a global optimization of the plasmonic glass problem, but rather to show the possibility of designing efficient glasses using rationally chosen sets of nanocrystal parameters and a relatively simple optimization algorithm.

While the present study concerns metafilms incorporating NCs of the same shape and material, a metafilm comprising NCs of different shapes and materials is also possible, as was suggested and realized in Zhang, H.; Demir, H. V.; Govorov, A. O. Plasmonic Metamaterials and Nanocomposites with the Narrow Transparency Window Effect in Broad Extinction Spectra. ACS Photonics 2014, 1 (9), 822-832; Besteiro, L. V.; Gungor, K.; Demir, H. V.; Govorov, A. O. Simple and Complex Metafluids and Metastructures with Sharp Spectral Features in a Broad Extinction Spectrum: Particle-Particle Interactions and Testing the Limits of the Beer-Lambert Law. J. Phys. Chem. C 2017, 121 (5), 2987-2997; and Yang, J.; Kramer, N. J.; Schramke, K. S.; Wheeler, L. M.; Besteiro, L. V.; Hogan, C. J.; Govorov, A. O.; Kortshagen, U. R. Broadband Absorbing Exciton-Plasmon Metafluids with Narrow Transparency Windows. Nano Lett. 2016, 16 (2), 1472-1477. Alternatively, a collection of complexes made of interacting excitonic and plasmonic components can be considered [Wiederrecht, G. P.; Wurtz, G. A.; Hranisavljevic, J. Coherent Coupling of Molecular Excitons to Electronic Polarizations of Noble Metal Nanoparticles. Nano Lett. 2004, 4 (11), 2121-2125; Zhang, W.; Govorov, A. O.; Bryant, G. W. Semiconductor-Metal Nanoparticle Molecules: Hybrid Excitons and the Nonlinear Fano Effect. Phys. Rev. Lett. 2006, 97(14), 146804; DeLacy, B. G.; Miller, O. D.; Hsu, C. W.; Zander, Z.; Lacey, S.; Yagloski, R.; Fountain, A. W.; Valdes, E.; Anquillare, E.; Soljačić, M.; et al. Coherent Plasmon-Exciton Coupling in Silver Platelet-J-Aggregate Nanocomposites. Nano Lett. 2015, 15 (4), 2588-2593; Zhou, X.; Wenger, J.; Viscomi, F. N.; Le Cunff, L.; Béal, J.; Kochtcheev, S.; Yang, X.; Wiederrecht, G. P.; Colas des Francs, G.; Bisht, A. S.; et al. Two-Color Single Hybrid Plasmonic Nanoemitters with Real Time Switchable Dominant Emission Wavelength. Nano Lett. 2015, 15 (11), 7458-7466; and Soganci, I. M.; Nizamoglu, S.; Mutlugun, E.; Akin, O.; Demir, H. V. Localized Plasmon-Engineered Spontaneous Emission of CdSe/ZnS Nanocrystals Closely-Packed in the Proximity of Ag Nanoisland Films for Controlling Emission Linewidth, Peak, and Intensity. Opt. Express 2007, 15 (22), 14289]. Molecular aggregates [Saikin, S. K.; Eisfeld, A.; Valleau, S.; Aspuru-Guzik, A. Photonics Meets Excitonics: Natural and Artificial Molecular Aggregates. Nanophotonics 2013, 2 (1)] or metal-atom clusters [Nguyen, T. K. N.; Renaud, A.; Wilmet, M.; Dumait, N.; Paofai, S.; Dierre, B.; Chen, W.; Ohashi, N.; Cordier, S.; Grasset, F.; et al. New Ultra-Violet and near-Infrared Blocking Filters for Energy Saving Applications: Fabrication of Tantalum Metal Atom Cluster-Based Nanocomposite Thin Films by Electrophoretic Deposition. J Mater Chem C 2017, 5 (40), 10477-10484] can also be used as strongly absorbing components. Plasmonic media incorporating nanocrystal assemblies can be made active using soft-matter responsive materials as a matrix [De Sio, L.; Caputo, R.; Cataldi, U.; Umeton, C. Broad Band Tuning of the Plasmonic Resonance of Gold Nanoparticles Hosted in Self-Organized Soft Materials. J. Mater. Chem. 2011, 21 (47), 18967].

Nanotechnology offers at least two efficient techniques to fabricate simple and complex NCs: colloidal chemistry [Wiederrecht, G. P.; Wurtz, G. A.; Hranisavljevic, J. Coherent Coupling of Molecular Excitons to Electronic Polarizations of Noble Metal Nanoparticles. Nano Lett. 2004, 4 (11), 2121-2125; DeLacy, B. G.; Miller, O. D.; Hsu, C. W.; Zander, Z.; Lacey, S.; Yagloski, R.; Fountain, A. W.; Valdes, E.; Anquillare, E.; Soljačić, M.; et al. Coherent Plasmon-Exciton Coupling in Silver Platelet-J-Aggregate Nanocomposites. Nano Lett. 2015, 15 (4), 2588-2593; Zhang, J.; Tang, Y.; Lee, K.; Ouyang, M. Tailoring Light-matter-spin Interactions in Colloidal Hetero-Nanostructures. Nature 2010, 466 (7302), 91-95; and Weng, L.; Zhang, H.; Govorov, A. O.; Ouyang, M. Hierarchical Synthesis of Non-Centrosymmetric Hybrid Nanostructures and Enabled Plasmon-Driven Photocatalysis. Nat. Commun. 2014, 5, 4792] and gas-phase deposition methods [Ye, J.; Verellen, N.; Van Roy, W.; Lagae, L.; Maes, G.; Borghs, G.; Van Dorpe, P. Plasmonic Modes of Metallic Semishells in a Polymer Film. ACS Nano 2010, 4 (3), 1457-1464; Van Dorpe, P.; Ye, J. Semishells: Versatile Plasmonic Nanoparticles. ACS Nano 2011, 5 (9), 6774-6778; Frederiksen, M.; Bochenkov, V. E.; Cortie, M. B.; Sutherland, D. S. Plasmon Hybridization and Field Confinement in Multilayer Metal-Dielectric Nanocups. J. Phys. Chem. C 2013, 117 (30), 15782-15789; Qin, Y.; Kong, X.-T.; Wang, Z.; Govorov, A. O.; Kortshagen, U. R. Near-Infrared Plasmonic Copper Nanocups Fabricated by Template-Assisted Magnetron Sputtering. ACS Photonics 2017, 4 (11), 2881-2890; and Manandhar, K.; Wollmershauser, J. A.; Feigelson, B. N. Growth Mode of Alumina Atomic Layer Deposition on Nanopowders. J. Vac. Sci. Technol. Vac. Surf. Films 2017, 35 (4), 041503]. Several recent papers reported the fabrication of NCs using gas-phase deposition methods; with related NC designs including nanocups [Ye, J.; Verellen, N.; Van Roy, W.; Lagae, L.; Maes, G.; Borghs, G.; Van Dorpe, P. Plasmonic Modes of Metallic Semishells in a Polymer Film. ACS Nano 2010, 4 (3), 1457-1464; Van Dorpe, P.; Ye, J. Semishells: Versatile Plasmonic Nanoparticles. ACS Nano 2011, 5 (9), 6774-6778; and Qin, Y.; Kong, X.-T.; Wang, Z.; Govorov, A. O.; Kortshagen, U. R. Near-Infrared Plasmonic Copper Nanocups Fabricated by Template-Assisted Magnetron Sputtering. ACS Photonics 2017, 4 (11), 2881-2890], complex multilayer nano-cups, [Frederiksen, M.; Bochenkov, V. E.; Cortie, M. B.; Sutherland, D. S. Plasmon Hybridization and Field Confinement in Multilayer Metal-Dielectric Nanocups. J. Phys. Chem. C 2013, 117 (30), 15782-15789] and nanoshells [Manandhar, K.; Wollmershauser, J. A.; Feigelson, B. N. Growth Mode of Alumina Atomic Layer Deposition on Nanopowders. J. Vac. Sci. Technol. Vac. Surf. Films 2017, 35 (4), 041503].

Results for Nanocrystals with Sharp and Tunable Plasmonic Resonances.

Metaglasses Made of Nanoshells of Ag, Au, Al, Cu, and TiN

Using available experimental data for bulk optical dielectric constants of the plasmonic crystals of interest, this portion of the study describes computed extinctions for a set of illustrative sizes in a few different geometries. FIG. 14, panel a, shows a typical spectrum of nanoshells, using a Ag nanoshell as an illustrative example. Its extinction spectrum has its major peak due to a dipolar plasmon, one minor peak due to a quadrupolar excitation, and an UV band appearing due to Ag interband transitions (FIG. 14, panel a). The major dipolar peak is of interest here. The spectra of Ag and Cu nanoshells are given in FIG. 14, panel b, whereas the spectra of the other NCs are described in the Supporting Information section (below).

In the next step, sets of NCs which can efficiently block solar IR radiation but do not attenuate in the visible interval are prepared. To choose such sets of particles, a range of material and geometrical properties of nanostructures were explored. As is well-known, and shown in FIG. 14, the plasmon peak of a NC depends strongly on its size, whereas the interband transitions are not spectrally tunable. Therefore, sizes of NCs with plasmon peaks in the IR are selected and, simultaneously materials with interband transitions in the UV are chosen to avoid the attenuation of visible light. Taking the nanoshells as an example, the shell thickness is kept constant, the core diameter is changed, and various suitable material systems are sampled. In addition, TiO₂ spherical NCs (a=10 nm) are included to block light in the UV interval. Table 1 summarizes the sets of NC densities that create metafilms with best performance, given the range of NC sizes under consideration.

TABLE 1
Summary of Concentrations of NCs Used To Calculate the Properties of IR
Blocking Metaglasses with a thickness of 4 mm. These are the densities obtained by
manually optimizing the glasses' transmission profiles, accounting for both T_{direct} and T_{diffuse}.

| | Shape | | |
|---|---|---|---|
| | Nanoshells | Nanorod | Nanocup |
| Material | (a, w) (nm): n (m⁻³) | (d, L) (nm): n (m⁻³) | (a, w) (nm): n (m⁻³) |
| Ag | TiO₂: 10²¹ | TiO₂: 10²¹ | TiO₂: 10²¹ |
| | (200, 5): 2 · 10¹⁶ | (10, 38): 2 · 10¹⁸ | (150, 14): 4 · 10¹⁵ |
| | | (10, 45): 5 · 10¹⁷ | (250, 16): 3 · 10¹⁵ |
| | | (10, 59): 9 · 10¹⁷ | |
| | | (10, 81): 4 · 10¹⁷ | |
| | | (10, 102): 2 · 10¹⁷ | |
| Au | TiO₂: 10²¹ | TiO₂: 10²¹ | TiO₂: 10²¹ |
| | (50, 5): 10¹⁶ | (10, 24): 3 · 10¹⁷ | (150, 14): 3 · 10¹⁵ |
| | (80, 5): 6 · 10¹⁵ | (10, 29): 2 · 10¹⁷ | (250, 16): 3 · 10¹⁵ |
| | (130, 5): 10¹⁵ | (10, 38): 6 · 10¹⁷ | |
| | (150, 5): 10¹⁵ | (10, 45): 10¹⁷ | |
| | (180, 5): 2 · 10¹⁵ | (10, 59): 3 · 10¹⁷ | |
| | (200, 5): 6 · 10¹⁵ | (10, 81): 2 · 10¹⁷ | |
| | | (10, 102): 7 · 10¹⁶ | |
| Al | TiO₂: 10²¹ | TiO₂: 10²¹ | TiO₂: 10²¹ |
| | (200, 5): 5 · 10¹⁵ | (10, 102): 5 · 10¹⁷ | (250, 16): 3 · 10¹⁵ |
| Cu | TiO₂: 10²¹ | TiO₂: 10²¹ | TiO₂: 10²¹ |
| | (50, 5): 4 · 10¹⁵ | (10, 29): 5 · 10¹⁷ | (150, 14): 2 · 10¹⁵ |
| | (80, 5): 3 · 10¹⁵ | (10, 38): 2 · 10¹⁷ | (250, 16): 3 · 10¹⁵ |
| | (100, 5): 5 · 10¹⁵ | (10, 45): 2 · 10¹⁷ | |
| | (130, 5): 5 · 10¹⁵ | (10, 59): 2 · 10¹⁷ | |
| | (150, 5): 10¹⁵ | (10, 81): 10¹⁷ | |
| | (200, 5): 5 · 10¹⁵ | (10, 102): 2 · 10¹⁷ | |
| TiN | TiO₂: 10²¹ | TiO₂: 10²¹ | TiO₂: 10²¹ |
| | (30, 5): 3 · 10¹⁶ | (10, 29): 10¹⁸ | (150, 14): 10¹⁶ |
| | (50, 5): 4 · 10¹⁶ | (10, 45): 7 · 10¹⁷ | |
| | (80, 5): 4 · 10¹⁵ | (10, 81): 4 · 10¹⁷ | |
| | (130, 5): 4 · 10¹⁵ | | |
| | (200, 5): 7 · 10¹⁵ | | |

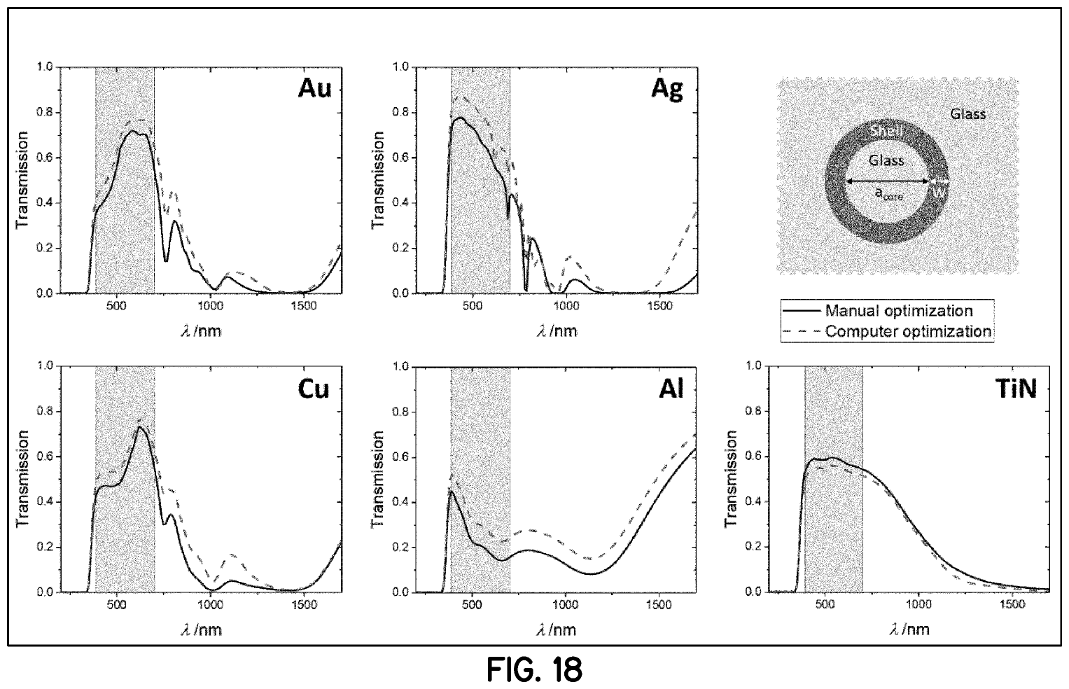

FIG. 18 shows the transmission profiles for glasses composed with nanoshells of different materials, and summarizes the main results of the study of this Example 2. Because silver has no interband transition in the visible and exhibits very sharp plasmonic resonances, it demonstrates the best performance in the calculations. In fact, silver is already widely used for coatings in window technologies [Carmody, J.; Selkowitz, S.; Heschong, L. Residential Windows: A Guide to New Technologies and Energy Performance, 1st. Ed.; Norton: New York, 1996; and Pacheco-Torgal, F. Eco-Efficient Materials for Mitigating Building Cooling Needs; Elsevier: Boston, Mass., 2015]. Commercial windows with multilayer coating, including a layer of silver, can reflect solar IR light, but with the drawback of being relatively expensive. The performance of gold nanoshells is also good but gold is significantly more expensive. Among the alternative inexpensive materials, copper and TiN perform well, but the hybridized high-energy mode of the Al shell [Prodan, E.; Radloff, C.; Halas, N. J.; Nordlander, P. A Hybridization Model for the Plasmon Response of Complex Nanostructures. Science 2003, 302 (5644), 419-422] falls on the visible range, making aluminum a less suitable material in the nanoshell geometry.

Nanocrystals with Various Shapes

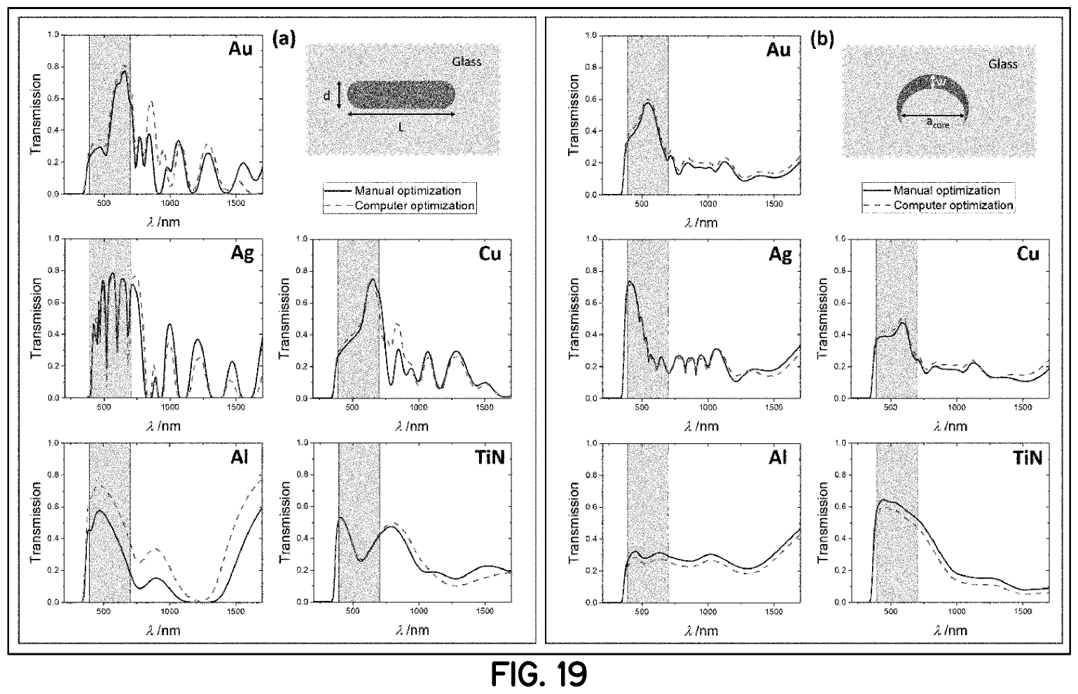

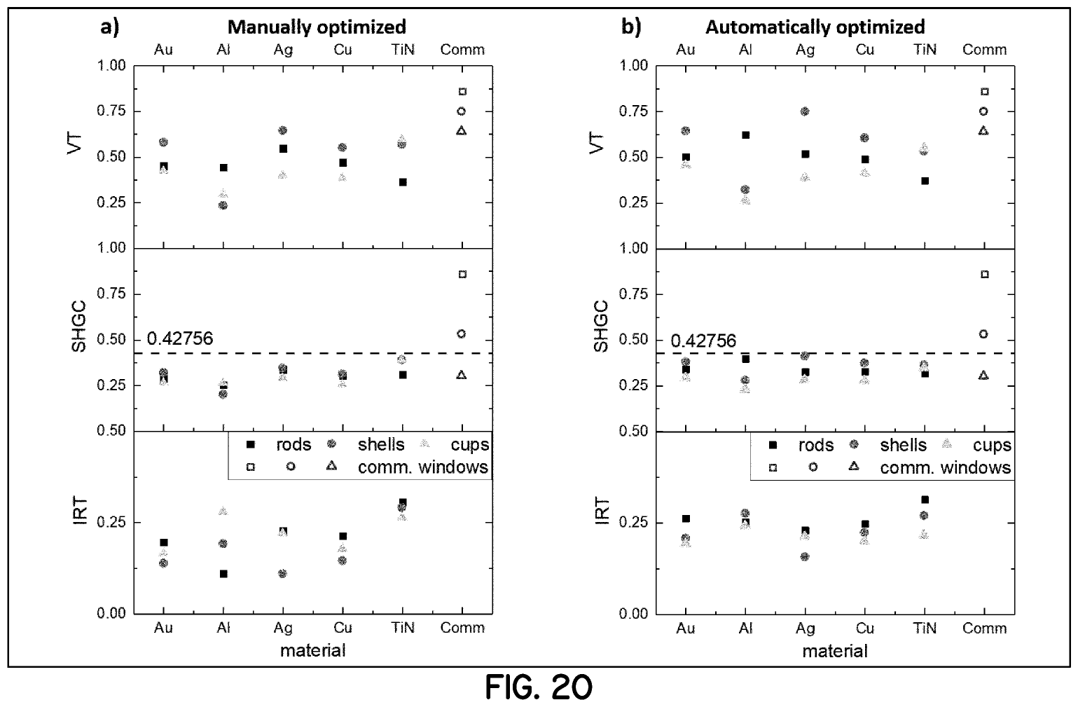

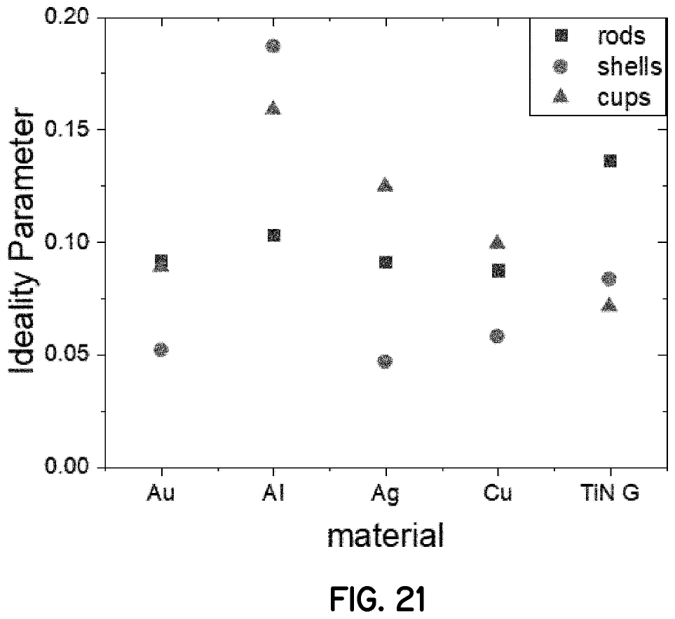

FIGS. 18 and 19 show the transmission profiles of the glasses obtained by both manual optimization (see Table 1) and computer optimization (see Table 2) for each of the considered materials and geometries. Each panel of the Figures depicts a glass that includes a single combination of geometry (shells, rods, cups) and material (Ag, Ag, Cu, Al, TiN). Although the results for manual and automatic optimization are very similar, their differences illustrate the fact that the parametric space defined by the NC densities offer many local minima with comparable values of IP. To quantitatively compare different materials and shapes, the figures of merit (see section on Beer-Lambert law) were then completed from the transmissions in FIGS. 18 and 19. FIG. 20 shows these results, taken from the manually and computationally optimized glasses (solid black and dashed red curves, respectively, in FIGS. 18 and 19). An optimal plasmonic glass would offer VT=1, IRT=0, and SHGC=0.43. Among the options considered, the nanoshells provide the best results overall, particularly when using silver. Copper is also a suitable candidate for applications of this kind, as well as Al nanorods and TiN nanocups (FIG. 20). Overall, FIG. 20 shows that the nanoshell shapes give the best performances for the parameter VT for the majority (Au, Ag, Cu) of the considered plasmonic materials; for TiN, the nanoshells and nanocups have similar numbers for VT. Simultaneously, these shapes provide good values (below 0.43) for the SHGC parameter. Complementing the physically relevant parameters in this figure, one can also gauge the efficiency of a given plasmonic glass by examining its IP value (FIG. 21). Here, again, the nanoshells perform the best, giving the smallest IP for Au, Ag, and Cu. The nanocup shape gives the smallest IP for TiN and again Al is the most suitable material for the nanorod glass.

TABLE 2
Summary of concentrations of NCs used to calculate the properties of IR
blocking metaglasses with a thickness of 4 mm. These are the densities obtained by
computationally optimizing the glasses' transmission profiles, accounting for both T_{direct} and T_{diffuse}.

| | Shape | | |
|---|---|---|---|
| | Nanoshells | Nanorod | Nanocup |
| Material | (a, w (nm): n (m⁻³) | (d, L) (nm): n (m⁻³) | (a, w) (nm): n (m⁻³) |
| Ag | TiO₂: 10²¹ | TiO₂: 10²¹ | TiO₂: 10²¹ |
| | (80, 5): 3.4 · 10¹⁵ | (10, 38): 8.1 · 10¹⁷ | (150, 14): 2.8 · 10¹⁵ |
| | (130, 5): 6.2 · 10¹⁴ | (10, 45): 6.7 · 10¹⁷ | (250, 16): 3.5 · 10¹⁵ |
| | (150, 5): 1.3 · 10¹⁵ | (10, 59): 1.5 · 10¹⁸ | |
| | (180, 5): 3.9 · 10¹⁵ | (10, 81): 4.1 · 10¹⁷ | |
| | (200, 5): 6.1 · 10¹⁵ | (10, 102): 3.9 · 10¹⁷ | |
| Au | TiO₂: 10²¹ | TiO₂: 10²¹ | TiO₂: 10²¹ |
| | (50, 5): 3.7 · 10¹⁶ | (10, 24): 2.0 · 10¹⁷ | (150, 14): 2.9 · 10¹⁵ |
| | (80, 5): 2.8 · 10¹⁵ | (10, 29): 1.8 · 10¹⁷ | (250, 16): 2.7 · 10¹⁵ |
| | (100, 5): 2.7 · 10¹⁵ | (10, 38): 1.3 · 10¹⁷ | |
| | (130, 5): 1.2 · 10¹⁵ | (10, 45): 2.4 · 10¹⁷ | |
| | (200, 5): 6.1 · 10¹⁵ | (10, 59): 2.3 · 10¹⁷ | |
| | | (10, 81): 1.4 · 10¹⁷ | |
| | | (10, 102): 2.2 · 10¹⁷ | |
| Al | TiO₂: 10²¹ | TiO₂: 10²¹ | TiO₂: 10²¹ |
| | (200, 5): 3.9 · 10¹⁵ | (10, 81): 4.4 · 10¹⁷ | (250, 16): 3.3 · 10¹⁵ |
| | | (10, 102): 2.35 · 10¹⁷ | |
| Cu | TiO₂: 10²¹ | TiO₂: 10²¹ | TiO₂: 10²¹ |
| | (50, 5): 2.8 · 10¹⁵ | (10, 24): 1.8 · 10¹⁷ | (150, 14): 2.6 · 10¹⁵ |
| | (80, 5): 2.6 · 10¹⁵ | (10, 29): 1.6 · 10¹⁷ | (250, 16): 2.5 · 10¹⁵ |
| | (100, 5): 1.7 · 10¹⁵ | (10, 38): 1.3 · 10¹⁷ | |
| | (150, 5): 7.9 · 10¹⁵ | (10, 45): 2.4 · 10¹⁷ | |
| | (200, 5): 5.1 · 10¹⁵ | (10, 59): 2.2 · 10¹⁷ | |
| | | (10, 81): 1.2 · 10¹⁷ | |
| | | (10, 102): 1.9 · 10¹⁷ | |
| TiN | TiO₂: 10²¹ | TiO₂: 10²¹ | TiO₂: 10²¹ |
| | (50, 5): 2.9 · 10¹⁶ | (10, 29): 4.3 · 10¹⁷ | (150, 14): 1.2 · 10¹⁶ |
| | (100, 5): 5.3 · 10¹⁵ | (10, 38): 3.0 · 10¹⁷ | |
| | (130, 5): 1.4 · 10¹⁵ | (10, 45): 7.0 · 10¹⁷ | |
| | (180, 5): 3.0 · 10¹⁵ | (10, 59): 2.2 · 10¹⁷ | |
| | (200, 5): 6.4 · 10¹⁵ | (10, 81): 2.9 · 10¹⁷ | |

For comparison, in FIG. 20, parameters of some commercial glasses are also provided [Carmody, J.; Selkowitz, S.; Heschong, L. Residential Windows: A Guide to New Technologies and Energy Performance, 1st. Ed.; Norton: New York, 1996; and Seven Sun Windows. Insulating Glass http://www.sevensunwindows.com/windows/replacement/glass (accessed Dec. 29, 2017)]. It can be seen that the plasmonic glasses described herein look very promising and may compete with current commercial products. The parameter VT for the plasmonic metaglasses is slightly lower than those for the commercial glasses with low-E coatings, but plasmonic glasses can be made from cheaper materials (Cu, TiN, and Al). In addition, the parameter SHGC for plasmonic glasses is close to the optical limit.

Guidelines To Design an IR-Blocking Spectrum with Plasmonic Nanocrystals.

Finally, herein a set of rules is formulated on how to create efficient metaglass designs. By modeling NCs of several distinct shapes and different plasmonic materials, it was observed that, to achieve a high-quality IR blocking glass, one should consider the following guidelines:

1. Sizes of plasmonic NCs should be as small as possible to obtain sharper plasmon peaks. Small NCs are better since their plasmonic resonances don't show radiative broadening; the width of the plasmonic peak in small NCs in the IR interval is given by the Drude broadening constant of a metal. Yet, it was assumed here that the NC size should be larger than a few nanometers, to display plasmonic character.

2. Spherical NCs are not very useful. They do not have enough tunability of their plasmon energy. Large spherical NCs have broad peaks (Mie resonances) with a very strong radiative broadening [Asano, S.; Yamamoto, G. Light Scattering by a Spheroidal Particle. Appl. Opt. 1975, 14 (1), 29].

3. In the case of nanoshells, one should use shells with small widths. This reduces the total material volume, thus producing a weaker interband absorption in the visible interval.

4. Use materials with interband transitions in the UV range. Such materials may be of a silver-like color.

5. Because the extinction spectrum of a metaglass depends on both plasmonic resonances and interband spectral structures, one should sample several NC geometries. For example, Al nanorods have shown a good performance, whereas Al nanoshells were not found particularly suitable.

6. Nanoshells are especially promising and convenient for the proposed optical engineering. The physical reason for this is the following: A nanoshell has spherical symmetry, thus showing the same plasmonic modes regardless of its orientation with respect to the incoming light, whereas nanocups and nanorods are anisotropic and have different dipolar plasmons for their nonequivalent directions. Therefore, the plasmon modes in nanoshells are more spectrally localized than in nanocups and have plasmonic peaks with polarization-averaged intensities larger than those in nanorods, offering very convenient properties for designing isotropic optical media.

Regarding the potential applications and fabrication of metafilms, the following remarks apply: (1) Alternative inexpensive materials, such as Cu, TiN, or Al are promising. As it was demonstrated above, Cu and TiN nanoshells and TiN nanocups can create IR-blocking glasses with an overall good performance. Also, Al nanorods offer decent values for the figures of merit. (2) Gas-phase templated deposition using polymer and glass nanospheres allows the fabrication of nanoshells and nanocups with variable sizes [Ye, J.; Verellen, N.; Van Roy, W.; Lagae, L.; Maes, G.; Borghs, G.; Van Dorpe, P. Plasmonic Modes of Metallic Semishells in a Polymer Film. ACS Nano 2010, 4 (3), 1457-1464; Frederiksen, M.; Bochenkov, V. E.; Cortie, M. B.; Sutherland, D. S. Plasmon Hybridization and Field Confinement in Multilayer Metal-Dielectric Nanocups. J. Phys. Chem. C 2013, 117 (30), 15782-15789; Qin, Y.; Kong, X.-T.; Wang, Z.; Govorov, A. O.; Kortshagen, U. R. Near-Infrared Plasmonic Copper Nanocups Fabricated by Template-Assisted Magnetron Sputtering. ACS Photonics 2017, 4 (11), 2881-2890; and Manandhar, K.; Wollmershauser, J. A.; Feigelson, B. N. Growth Mode of Alumina Atomic Layer Deposition on Nanopowders. J. Vac. Sci. Technol. Vac. Surf. Films 2017, 35 (4), 041503]. Therefore, nanoshells and nanocups seem to be the most technologically accessible shapes. Simultaneously, colloidal nanocrystals fabricated with wet chemistry can also be used in principle, but in general they are costlier and need special techniques for drying them without aggregation.

Supporting Information

Extinction Cross Sections from Simulation

FIGS. 15-17 show the extinction cross sections of the different NCs used in this study, as obtained through electrodynamic simulations using the commercial COMSOL® package. The results are obtained for isolated NCs immersed in an infinite dielectric substrate (glass, with a refractive index of n=1.5) and illuminated by linearly polarized light. Averaged data from three orthogonal incidences of light, and two orthogonal linear polarizations for each direction of propagation are presented. The extinction cross sections contain information about the NC's absorption and scattering (σₑₓₜ=σ_{abs}+σ_{scattering}).

Formalism for Glass Optimization

As described above, the NC composition of the different plasmonic glasses attempts to reproduce an ideal transmission profile (FIG. 12, panel d), fully transparent to visible light and fully opaque to both UV and near IR regions of the electromagnetic spectrum:

$${T}_{idea l} = \{ \begin{matrix}1 , & 390 nm \leq λ \leq 700 nm \\ 0 , & λ < 390 nm or λ > 700 nm\end{matrix}$$

It was determined that one can then define a metric that characterizes how different a given transmission profile is from the ideal one, with the following being the one adopted in the present study:

$$IP ( {n}_{i} ) = \frac{{\int }_{200}^{1700} {f ( λ ) [ T ( {n}_{i} , λ ) - {T}_{d e a l} ]}^{2} d λ}{{\int }_{200}^{1700} f ( λ ) d λ}$$

where T(nᵢ, λ) is calculated using the Beer-Lambert law alone (T_{dir}) or also including the diffusion of scattered photons (T_{dir}+T_{diff}), taking cross sections σᵢ(λ) and optical path Lₒₚₜ as parameters and the full set of NC densities nᵢ as variables. Additionally, the scalar dimensionless function ƒ(λ) is included here as a tool to weight preferentially different spectral regions, but the results presented in this study use only a flat ƒ(λ)=1.

Having defined a metric for the distance between an arbitrary transmission profile and the one that was determined as the target, sets of NC densities, n, can be found that minimize this distance IP(n). Given the relatively small set of geometries used in each of the plasmonic glasses, preliminary values for the components of n that simultaneously provide (1) low values of IP(n) and (2) a comparatively low total material volume of NCs were first manually selected. The choices of densities were informed by the observation of the different NCs' extinction profiles. As a second step, these manually designed glasses were compared with those obtained through an algorithmic search of the space of possible NC densities. The search was conducted as follows:

Using IP(n) as the objective function, the BFGS method [Fletcher, R. Practical Methods of Optimization, 2 ed.; Wiley: Chichester, 2008] was used to find the set of densities, n, that minimizes it. This function has a large number of local minima, and the minimization method will only find the minimum of the basin of attraction in which the original ansatz for n lies. Therefore, the basin-hopping algorithm [Wales, D. J. Energy Landscapes; Cambridge University Press: Cambridge, 2003] was used to sample the space defined by the densities nᵢ. As a final step, intended to reduce the total material invested in creating the plasmonic glass, once a strong candidate for a global minimum has been found a small set of alternative glasses are considered: one by one, each of the NC densities are set to zero; if the new IP (n′) is either smaller than IP (n), or the difference is below a threshold, the modified set n′ replaces the previous candidate set and becomes the benchmark to which one can compare the next alternative.

Notably, the glasses obtained with this method do not differ significantly from the manually chosen ones, as shown in FIGS. 18 and 19. Of course, with a larger set of possible NCs, the complexity of the optimization would increase, and one could expect that using an algorithmic approach such as this would be the most efficient tactic.

Finally, this procedure can be used to design plasmonic glasses with completely different transmission profiles, just by adjusting T_{ideal}.

Diffusion of Photons in the Plasmonic Glass

Direct (ballistic) photons strike the glass and can be absorbed and scattered. The scattered photons then diffuse in both directions, to the right and to the left (FIG. 12, panel b). The photons diffusing to the right surface of the pane contribute to the transmission and, therefore, should be counted. The photons that diffuse towards the left surface of the pane radiate to the outside. Then, the total transmission of the plasmonic glass should be written as (see also Equation 7):

$$T = {T}_{dir} + {T}_{diff} \\ {T}_{dir} = \frac{{I}_{t}}{{I}_{i}} = 1 {0}^{- OD} = {e}^{- {OD}_{e}}$$

The formalism of photon diffusion is based on the transport equation [Biomedical Photonics Handbook; Vo-Dinh, T., Ed.; CRC Press: Boca Raton, 2003]:

$$\frac{\partial q ( r , t )}{\partial t} - k {∇}^{2} q ( r , t ) = - \frac{q ( r , t )}{{τ}_{a}} + {G}_{s c a t} ( r , t )$$

in which the parameters are defined as follows.

1) q(r, t) is the local density of photon energy, having the units J/m³. Another related parameter is the local fluence rate Φ(r,t), which has the units W/m². The above parameters are related via

$$q ( r , t ) = \frac{Φ ( r , t )}{c}$$

2)

$$k = \frac{c}{3 α}$$

is the photon diffusion coefficient, in which

$$α = ( {\sum }_{i} {σ}_{i} {n}_{i} )$$

is the linear extinction coefficient, which can be split into two terms related to scattering and absorption

$$α = {α}_{s} + {α}_{a} = {\sum }_{i} {σ}_{i , s} {n}_{i} + {\sum }_{i} {σ}_{i , a} {n}_{i}$$

3) The absorption lifetime of a photon is given via the absorption coefficient

$$\frac{1}{{τ}_{a}} = c {α}_{a} = c {\sum }_{i} {σ}_{i , a} {n}_{i}$$

4) The function G_{scat} (r, t) is the source in the diffusion equation, coming from the scattering of the direct light beam striking the pane. This quantity has units of volume power density, W/m³, and is given by

G_{scat}(r, t)=αₛI(z)=αₛI₀e^{-αz}

where I(z)=I₀e^{-αz} is the intensity of the direct beam inside the glass, given by the Beer-Lambert law; I₀ is the external flux of incoming light.

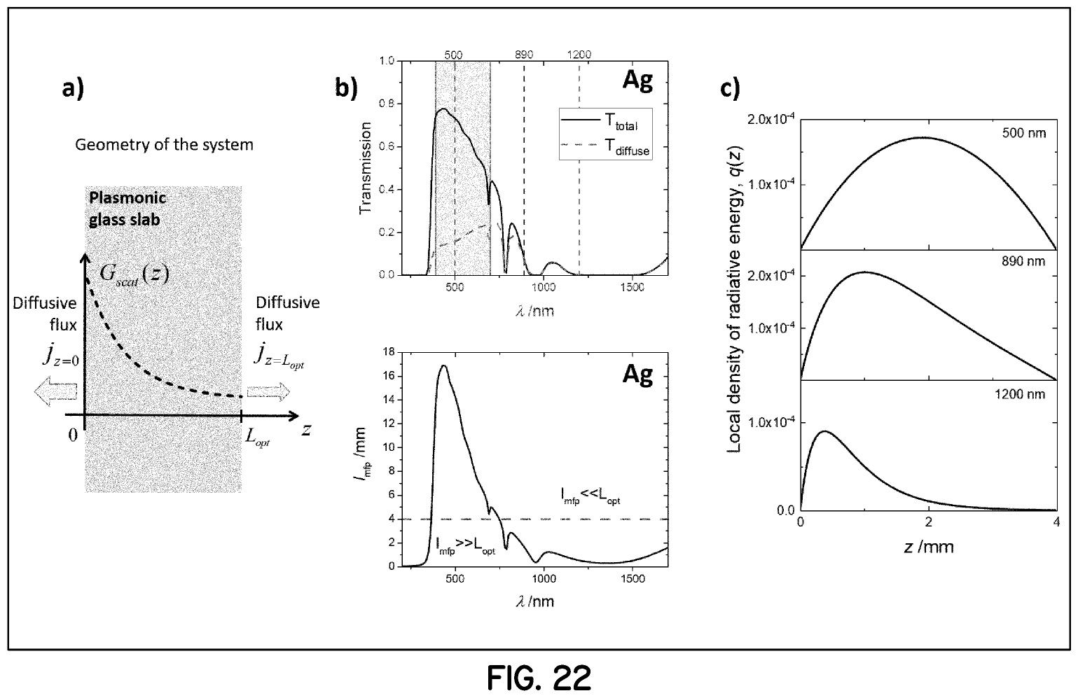

The boundary conditions are such that the local density of photon energy at the surfaces is small since, at the interface with air, photons are free to move without almost any scattering. In addition, the CW illumination regime with no time dependence and a one-dimensional setting was considered (FIG. 22, panel a). Therefore, the resulting simplified equation and the corresponding boundary conditions read:

$$\frac{{\partial }^{2} q ( z )}{\partial {z}^{2}} - {γ}^{2} q ( z ) = - \frac{{G}_{0}}{k} {e}^{- α z} \\ {G}_{0} = {α}_{s} {I}_{0} \\ γ = \frac{1}{\sqrt{k {τ}_{a}}} = \sqrt{3 {α}_{a} α} \\ q ( z = 0 ) = 0 \\ q ( z = {L}_{opt} ) = 0$$

This equation has a simple solution given by:

$$q ( z ) = a {e}^{- γ z} + b {e}^{γ z} + B {e}^{- a z} \\ B = \frac{- {G}_{0}}{k ( {α}^{2} - {γ}^{2} )} \\ a = \frac{- {G}_{0}}{k ( {α}^{2} - {γ}^{2} )} \frac{( {e}^{γ L} - {e}^{- α L} )}{( {e}^{- γ L} - {e}^{γ L} )}$$

$$b = - a - B = \frac{{G}_{0}}{k ( {α}^{2} - {γ}^{2} )} \frac{( {e}^{γ L} - {e}^{- α L} )}{( {e}^{- γ L} - {e}^{γ L} )} + \frac{{G}_{0}}{k ( {α}^{2} - {γ}^{2} )}$$

Then, the explicit analytical equation is

$$q ( z ) = \frac{{G}_{0}}{k ( {α}^{2} - {γ}^{2} )} \{ \frac{( - {e}^{γ L} + {e}^{- α L} )}{( {e}^{- γ L} - {e}^{γ L} )} {e}^{- γ z} + ( - \frac{( - {e}^{γ L} + {e}^{- α L} )}{( {e}^{- γ L} - {e}^{γ L} )} + 1 ) {e}^{γ z} - {e}^{- α z} \} \qquad ( S 1 )$$

The photon diffusive currents at the surfaces of the plasmonic glass slab are given by the transport equations:

$${{j}_{0 , {L}_{opt}} = - k \frac{\partial q ( z )}{\partial z} \vert}_{z = 0 , {L}_{opt}}$$

and these fluxes in the geometry (see FIG. 22, panel a) have the properties: j₀<0 and j_{L}_{ₒₚₜ}>0. For the diffusive transmission and for the total transmission, one would now have:

$${T}_{diff} = \frac{{j}_{{L}_{opt}}}{{I}_{0}}$$

$$T = {T}_{dir} + {T}_{diff} = {T}_{dir} + \frac{{j}_{{L}_{opt}}}{{I}_{0}}$$

$${T}_{diff} = \frac{- {α}_{s}}{( {α}^{2} - {γ}^{2} )} [ - \frac{( {e}^{- α L} - {e}^{γ L} )}{( {e}^{- γ L} - {e}^{γ L} )} γ {e}^{- γ L} + α {e}^{- α L} + \{ - \frac{( {e}^{- α L} - {e}^{γ L} )}{( {e}^{- γ L} - {e}^{γ L} )} + 1 \} γ {e}^{γ L} ]$$

An analytical diffusive transmission reads:

FIG. 22 shows the physics of photon diffusion in the system herein. The diffusive photons' generation source comes from the direct light beam and it is described by the Beer-Lambert Law: G_{scat}(z)=αₛI₀e^{-αz}. The distribution of photon energy for different wavelengths in the plasmonic glasses herein (results for the one with Ag-shells are shown in FIG. 22) are different for the visible and IR regions (FIG. 22, panel c). To understand this, the photon mean free path in this particular glass was observed (FIG. 22, panel b). The photonic mean free path in the slab is given by the averaged extinction

$${l}_{mfp} ( λ ) = 1 / ( {\sum }_{i} {σ}_{i} {n}_{i} ) = 1 / α$$

In the visible spectrum, the Ag-shell glass has a long photon mean free path, such that I_{mfp}(λ)>>Lₒₚₜ. Hence incident direct light creates scattered photons nearly uniformly through the slab and the diffusive photon density is a symmetric function, as seen in FIG. 22, panel c (the curve for 500nm). In the IR regime, the opposite strong inequality, l_{mfp}(λ)<<Lₒₚₜ, is present. Therefore, the diffusive photons are created now only near the left surface (FIG. 22, panel c, for 1200 nm). The photon energy distribution becomes strongly asymmetric. Direct photons become preferentially scattered at the left side of the glass and the energy diffuses towards the left surface. Then these diffusive photons radiate back to the air region. For the transition regime at 875 nm, a less strongly asymmetric function q(z) is observed.

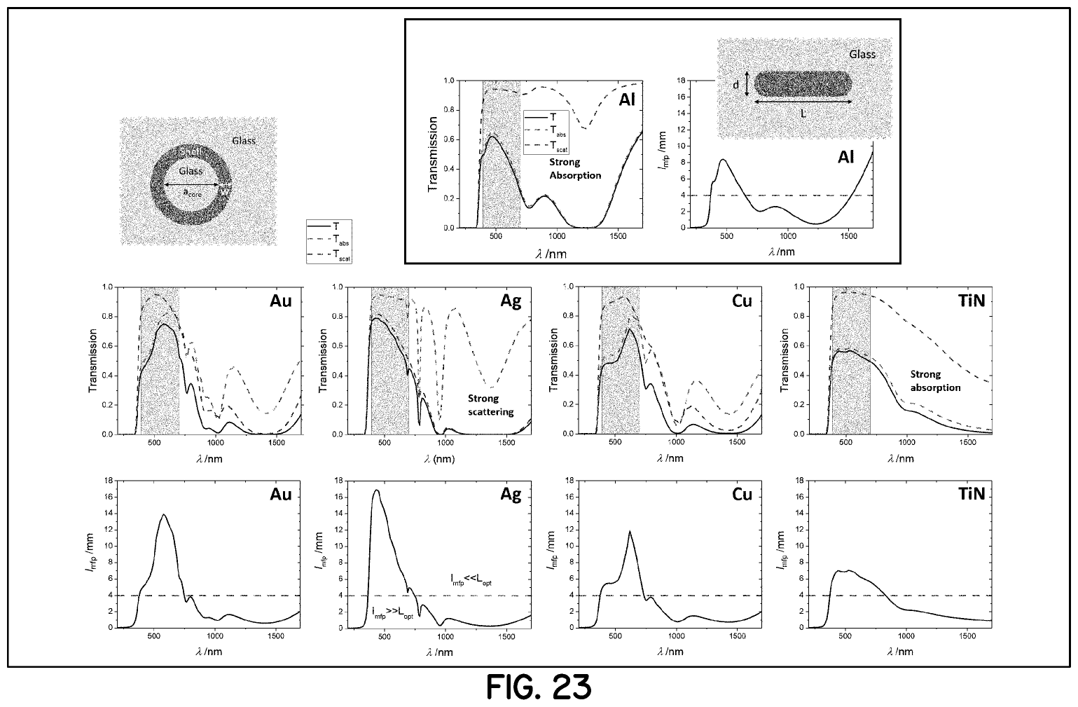

These two regimes of diffusive photon transport are determined the relation between the two transport-related lengths l_{mfp}(λ) and Lₒₚₜ. FIG. 23 now shows the comparison between these two lengths for different glasses. As expected, in all glasses, the two regimes of diffusion: l_{mfp}(λ)>Lₒₚₜ in the visible and l_{mfp}(λ)<Lₒₚₜ for the IR are observed. The first graph in each panel of FIG. 23 shows the two contributions to the direct transmission, due to scattering and absorption, as well as the total resulting transmission:

T_{dir}=T_{abs}=T_{scat}

T_{abs}=e^{-ODe,abs}, OD_{e,abs}=LₒₚₜΣσ_{i,abs}nᵢ

T_{scat}=e^{-ODe,scat}, OD_{e,scat}=LₒₚₜΣσ_{i,scat}nᵢ

The second graph in each panel of FIG. 23 depicts the comparison between the two relevant dimensions controlling the transmission of diffusive photons, l_{mfp} and Lₒₚₜ.

Overall, the diffusion transmission is not crucial for the performance of the glasses, but gives some corrections to the transmission spectra and the figures of merit for the glasses. For example, the figures of merit become changed by ˜6% at most for the best preforming glasses based on Ag, Cu and TiN NCs (FIG. 13). The values for VT improve and the values SHGC get increased correspondingly (so that the energy-saving properties of the glasses become reduced a little due to the diffusion). See FIG. 13 below for a few selected glasses, where computed figures of merit are also given.

Sample Polydispersity

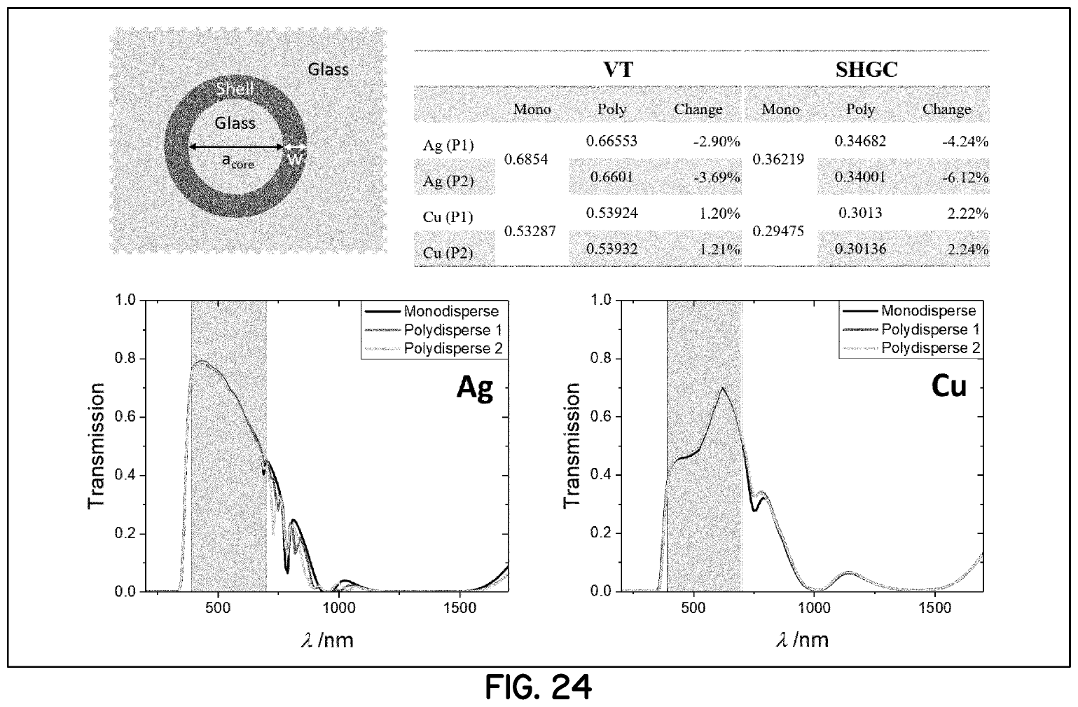

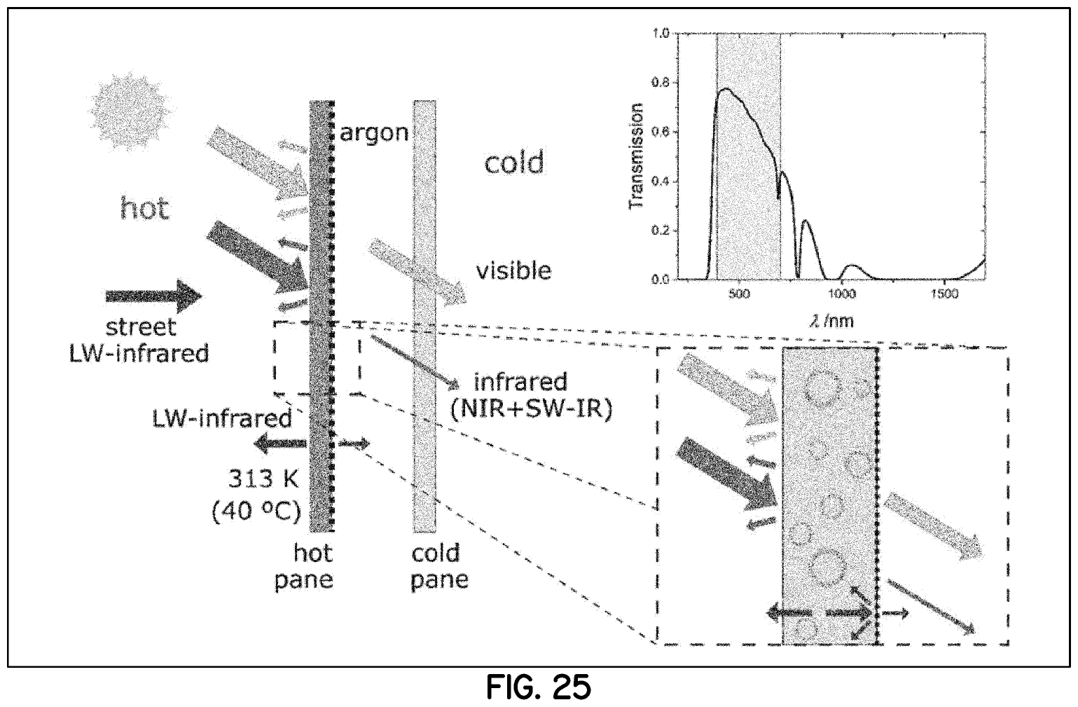

Any real system with a collection of NCs will exhibit some amount of dispersion on the NC size with respect to the nominal dimensions. To explore how much the filtering effect of the plasmonic glass depends on the NC polydispersity, the transmission profiles of two well-performing plasmonic glasses (Ag and Cu shells) were computed, including a dispersion of sizes for the nanocrystals that are the most relevant to the profile of these IR-blocking glasses (those which determine the drop on transmission at the visible-IR boundary at ˜700 nm). For the Ag-glass, this NC has the parameters (a_{core}=200 nm, w=5 nm) and, for the Cu-glass, such crucial NC has the parameters (a_{core}=50 nm, w=5 nm) (Table 3). The population of such crucial NCs is now split into three different particle sizes differing in one of its geometrical parameters, to test the effect of polydispersity. The resulting transmission profiles are presented in FIG. 24, accompanied by a table showing the change on the figures of merit. Overall, it is seen that the glasses' transmission profiles are relatively robust to these changes. This robustness was expected, because the transmission window in the visible spectral range in the glasses (FIGS. 18 and 19) does not have a very sharp boundary at the visible-IR interface and, therefore, some polydispersity cannot destroy the window effect and should not alter the figures of merit significantly.

### Conclusion

To conclude, the possibility of designing IR-blocking glasses using plasmonic NCs has been studied. While it is certainly tempting to use plasmonic elements to control the flow of light, there are some challenges to their implementation of economical, technological, and fundamental nature. For such applications, one should use relatively inexpensive plasmonic materials. In particular, herein it has been shown that NCs made of silver, copper, aluminum, and titanium nitride can be used to create plasmonic glasses with high performances, comparable to current commercial energy-saving windows. Technologically, one should be able to fabricate a set of NC with sizes suitable for blocking the solar IR range. Recent publications on templated gas-phase deposition techniques have demonstrated that this goal is achievable. Finally, the interband transition bands in the plasmonic materials impose fundamental limitations on the creation of sharp transmission windows for the visible interval. Nevertheless, using rational designs it is possible to overcome this limitation. By exploring a range of candidate materials and geometries for the embedded plasmonic NCs, part of the metaglass design space has been mapped, and, in doing so, guidelines to keep charting it with additional types of NCs have been provided. To conclude, this Example 2 has shown that the metaglass concept is indeed promising for practical applications, and can provide a potentially cheaper alternative to currently available window panes, which use a reflective multilayer structure including at least one layer of noble metal (mainly silver) [Fletcher, R. Practical Methods of Optimization, 2 ed.; Wiley: Chichester, 2008].

The work presented here can be extended in several directions. Most straightforwardly, examining mixed metaglass designs with different materials and geometries combined in the same pane, as they can provide improved optical properties. Additionally, further sampling of cheap materials and additional NC geometries can provide improved efficiency-to-cost ratios. Other approaches can change the target transmission spectra of the metaglass to, for example, one that affords specifically colored windows. Overall, one main result achieved in this study is a demonstration that transparent media with specially selected embedded plasmonic NCs can function as materials for windows with enhanced optical properties.

In summary, the need for energy-saving materials is pressing. This Example reports on the design of energy-saving glasses and films based on plasmonic nanocrystals that efficiently block infrared radiation. Designing such plasmonic composite glasses is nontrivial and requires to take full advantage of both material and shape-related properties of the nanoparticles. The performance of solar plasmonic glasses incorporating a transparent matrix and specially-shaped nanocrystals is computed. The performance of glasses made with a given nanocrystal ensemble depend on its shape and material. Glasses designed with plasmonic nanoshells are shown to exhibit overall better performances as compared to nanorods and nanoshells. Simultaneously, the synthesis of plasmonic nanoshells and nanocups is technologically feasible using gas-phase fabrication methods. The computational work was done for noble metals (gold and silver) as well as for alternative plasmonic materials (aluminum, copper and titanium nitride). Inexpensive plasmonic materials (silver, copper, aluminum and titanium nitride) show overall good performance in terms of the commonly-used figures of merit of industrial glass windows. Together with numerical data for specific materials, this Example includes a set of general rules for designing efficient plasmonic IR-blocking media. The plasmonic glasses proposed herein are good candidates for cheap optical media to be used in energy-saving windows in warm climates' housing or temperature-sensitive infrastructure.

The embodiments of the present invention recited herein are intended to be merely exemplary and those skilled in the art will be able to make numerous variations and modifications to it without departing from the spirit of the present invention. Notwithstanding the above, certain variations and modifications, while producing less than optimal results, may still produce satisfactory results. All such variations and modifications are intended to be within the scope of the present invention as defined by the claims appended hereto.

What is claimed is:

1. A composition comprising:
a first population of one or more plasmonic nanocrystals having a first, narrow extinction range; and
one or more additional populations of one or more plasmonic nanocrystals, each of the one or more additional populations having a unique additional, narrow extinction range,
wherein an absorbance spectrum of the composition is characterized by the first, narrow extinction range and the one or more additional, narrow extinction ranges that together block infrared light wavelengths, and the first and one or more additional populations is selected from the following group: a nanoshell, a nanostar, a nanocup, a nanoprism, and a combination thereof.

2. The composition of claim 1, wherein the plasmonic nanocrystals of the first and one or more additional populations comprise a material selected from the following group: gold, silver, copper, aluminum, titanium nitride (TiN), indium tin oxide (ITO), and a combination thereof.

3. The composition of claim 1, wherein the absorbance spectrum is tunable by varying a shell thickness of the first population of one or more plasmonic nanocrystals.

4. The composition of claim 1, further comprising:
a third population of at least one of a semiconductor nanocrystal or a dielectric nanocrystal, the third population having a third extinction range; and
wherein the absorbance spectrum of the composition is further characterized by the third extinction range and includes a transparency window characterized by a gap between the third extinction range and the first, narrow extinction range and the one or more additional narrow extinction ranges.

5. The composition of claim 4, wherein the third extinction range blocks ultraviolet light wavelengths.

6. The composition of claim 1, wherein the one or more plasmonic nanocrystals of the first population have a first size, and wherein the one or more additional populations include a second population of one or more plasmonic nanocrystals having a second size and a third population of one or more plasmonic nanocrystals having a third size, the first size being larger than the second size, and the second size being larger than the third size.

7. The composition of claim 6, wherein a ratio of the first population to the second population to the third population is 0.1:0.1:1.3.

8. A composition comprising:
a first population of one or more semiconductor nanocrystals having a first, broad extinction range being in the UV range; and
one or more additional populations of one or more plasmonic nanocrystals, each of the one or more additional populations having a unique additional, narrow extinction range in the infrared interval;
wherein an absorbance spectrum of the composition is characterized by the first, broad extinction range and the one or more additional, narrow extinction ranges that together block infrared light wavelengths, and the one or more additional populations is selected from the following group: a nanoshell, a nanostar, a nanocup, a nanoprism, a nanorod, and a combination thereof.

9. The composition of claim 8, wherein the first population of one or more semiconductor nanocrystals includes a nanosphere.

10. The composition of claim 8, wherein the semiconductor nanocrystals of the first population comprise a material selected from the following group: titanium dioxide (TiO₂), zinc oxide (ZnO), and a combination thereof.

11. The composition of claim 8, wherein the plasmonic nanocrystals of the one or more additional populations comprise a material selected from the following group: gold, silver, copper, aluminum, titanium nitride (TiN), indium tin oxide (ITO), and a combination thereof.

12. The composition of claim 8, wherein the plasmonic nanocrystals are nanoshells or nanocups, and wherein the absorbance spectrum is tunable by varying a shell thickness and a shell size of the plasmonic nanocrystals.

13. The composition of claim 8, wherein the plasmonic nanocrystals are nanoprisms or nanorods, and wherein the absorbance spectrum is tunable by varying a shell size of the plasmonic nanocrystals.

14. A filter comprising the composition of claim 1 embedded in a material, the filter providing a transparency to a defined wavelength range.

15. The filter of claim 14, wherein the defined wavelength range is in the visible spectrum.

16. The filter of claim 14, wherein the material is glass or a polymer.

17. A filter comprising the composition of claim 8 embedded in a material, the filter providing a transparency to a defined wavelength range.

18. A method of making a selective light wavelength filter comprising:
embedding the composition of claim 1 in an optically-transparent composite material.

19. A method of making a selective light wavelength filter comprising:
embedding the composition of claim 19 in an optically-transparent composite material.
